(19) United States
(12) Patent Application Publication
(10) Pub. No.: US 2017/0259412 A1
(43) Pub. Date: Sep. 14, 2017

(54) IMPACT TOOL

(71) Applicant: HITACHI KOKI CO., LTD., Tokyo (JP)

(72) Inventors: Tomomasa NISHIKAWA, Ibaraki (JP); Tetsuhiro HARADA, Ibaraki (JP); Satoru MATSUNO, Ibaraki (JP)

(21) Appl. No.: 15/500,244

(22) PCT Filed: Jul. 24, 2015
(86) PCT No.: PCT/JP2015/071124

§ 371 Date: Jan. 30, 2017

(30) Foreign Application Priority Data
Jul. 31, 2014 (JP) 2014-157216
Jul. 31, 2014 (JP) 2014-157223

(51) Int. Cl. B25B 21/02

(52) U.S. Cl. CPC B25B 21/026

(57) ABSTRACT

In order to suppress a galling phenomenon between an impact member and a rotating member even when a gouging force acts on an impact tool, an inclined portion is provided between a wall portion which is provided between a pair of hammer cams and in a circumferential direction of a through-hole and a bottom portion which is provided in each center portion of the hammer cams and in the circumferential direction of the through-hole, the inclined portion which has a smaller size than a size of the wall portion in the shaft direction of the through-hole and a larger size than a size of the bottom portion in the shaft direction of the through-hole and against which the spindle is pushed when the first pawl and the second pawl are engaged with each other.

### TECHNICAL FIELD

The present invention relates to an impact tool provided with an impact member which converts a torque of a rotating member into a torque and an impact force of an output member.

### BACKGROUND ART

Patent Document 1 describes an example of an impact tool provided with an impact member which converts a torque of a rotating member into a torque and an impact force of an output member. The impact tool described in Patent Document 1 is provided with a hammer (impact member) which converts a torque of a spindle (rotating member) into a torque and an impact force of an anvil (output member). A pair of spindle cams are provided in an outer circumferential portion of the spindle, a pair of hammer cams are provided in an inner circumferential portion of the hammer, and steel balls are arranged between the cams, respectively.

Two hammer pawls, arranged side by side in the circumferential direction at an equal interval, are provided in a portion of the hammer, the portion being closer to the anvil, and two anvil pawls, arranged side by side in the circumferential direction at an equal interval, are provided in a portion of the anvil, the portion being closer to the hammer. The hammer pawl and the anvil pawl are engaged with each other, and accordingly, the torque of the hammer is transmitted to the anvil. A tip tool such as a driver bit is attached to a portion on an opposite side of a portion closer to the hammer side in a shaft direction of the anvil.

Further, when a predetermined load is applied to the tip tool, a steel ball rolls following the spindle cam and the hammer cam. Accordingly, the hammer is separated from the anvil against a spring force of a coil spring, and then, approaches the anvil by the spring force of the coil spring. At this time, the hammer relatively rotates with respect to the anvil when being separated from the anvil, and the hammer pawl and the anvil pawl are engaged with each other and impact each other when the hammer approaches the anvil. An impact force in the rotation direction is generated at the tip tool repetition of opening and engagement between the hammer pawl and the anvil pawl.

### RELATED ART DOCUMENT

### Patent Document

Patent Document 1: Japanese Utility-Model Application Laid-Open Publication No. H01-170570

### SUMMARY OF THE INVENTION

### Problems to be Solved by the Invention

Meanwhile, a screw tightening work is performed in a state in which a rotation shaft of the impact tool and a rotation shaft of a fastening member (for example, a screw) do not match each other, a gouging force acts on the rotation shaft of the impact tool. Accordingly, the outer circumferential portion of the spindle is partially and strongly pushed against the inner circumferential portion. This case easily causes a so-called galling phenomenon in which relative rotation between the hammer and the spindle is difficult because they are adhered to each other.

FIGS. 16 and 17 are explanatory diagrams for describing a positional relation between a hammer pawl and an anvil pawl of a conventional impact tool. In the impact tool described in Patent Document 1 described above, as illustrated in FIGS. 16 and 17, two hammer cams 101a and 101b are provided in the inner circumferential portion of a hammer 100, and two hammer pawls 102a and 102b are provided in a portion of the hammer 100, the portion being closer to the anvil (closer to a front side in the drawing). The two hammer pawls 102a and 102b are disposed in a portion corresponding to a center portion CP of the two hammer cams 101a and 101b in the circumferential direction of the hammer 100 so as to face each other across a shaft center HC of the hammer 100.

When normal impact is performed, as illustrated in FIG. 17, the hammer pawl 102a of the hammer 100 impacts the anvil pawl 105a of the anvil 104, so that an impact force F1 is generated. Besides, the hammer pawl 102b impacts the anvil pawl 105b, so that an impact force F3 is generated. These impact forces are generated at the same time as each other, and thus, misalignment between the shaft center HC of the hammer 100 and a shaft center SC of a spindle 103 does not occur, and the galling phenomenon hardly occurs.

Meanwhile, as illustrated in FIG. 16, when the gouging force acts on the rotation shaft of the impact tool, the misalignment between the shaft center HC of the hammer 100 and the shaft center SC of the spindle 103 occurs as illustrated in the drawing with the broken line, and therefore, for example, only the hammer pawl 102a impacts the anvil pawl 105a of the anvil 104 so as to generate the impact force F1. At this moment, the hammer pawl 102b and the anvil pawl 105b do not impact each other. Thus, the impact force F3 balancing the impact force F1 is not generated, and therefore, a reaction force F2 of the impact force F1 acts on the spindle 103, and the spindle 103 is strongly pushed against a wall portion between the hammer cams 101a and 101b. Here, a corner portion Cis provided in the wall portion between the hammer cams 101a and 101b to which the reaction force F2 is applied, and thus, a strong load is applied to the corner portion C, and accordingly, the galling phenomenon is easily generated.

In addition, a configuration in which the two hammer pawls 102a and 102b are positioned at the wall portion between the hammer cams 101a and 101b may be also considered. In this configuration, when only one hammer pawl impacts the anvil pawl (for example, the hammer pawl positioned at a position of a right wall portion in FIG. 16 impacts), a reaction force of an impact force generated by the impact strongly pushes the spindle 103 against an inner center portion of the hammer cam 101a. Here, the center portion of the hammer cam 101a which is inside of the hammer 100 in a radial direction is a portion (hammer cam bottom portion) having the smallest contact area with the spindle 103. Therefore, a surface pressure of the inner center portion per unit area is large so that the galling phenomenon is easily generated.

In addition, the spindle cam and the hammer cam are coated with a predetermined amount of grease (lubricant) in order to smooth the rolling of the steel ball. That is, inside of a hammer case where the hammer is housed is filled with the grease. Meanwhile, at an end portion of the hammer cam in the shaft direction, a relatively large opening portion through which the steel ball can be observed is provided. Accordingly, whenever the hammer moves backward and forward from the anvil, that is, whenever the hammer performs an impact operation, the grease adhering to the steel ball, the spindle cam, or the hammer cam leaks to the outside due to its oscillation.

In the impact tool described in Patent Document 1, as illustrated in FIG. 18, a center portion of the hammer cam in the circumferential direction of the hammer is largely opened during the impact operation. The steel ball is disposed in the center portion of the hammer cam in the circumferential direction of the hammer. Therefore, the impact tool described in Patent Document 1 is configured to easily leak the grease adhering to the steel ball, the spindle cam or the hammer cam to the outside due to the oscillation during the impact operation. When the grease leaks to the outside, the smooth rolling of the steel ball is difficult, which may result in a problem in which the spindle cam and the hammer cam, and besides, the steel ball are worn out early.

An object of the present invention is to provide an impact tool that is capable of suppressing a galling phenomenon between an impact member and a rotating member even when a gouging force acts on the impact tool.

In addition, another object of the present invention is to provide the impact tool that is capable of suppressing leak of grease adhering to a steel ball to the outside of a cam groove.

### Means for Solving the Problems

An aspect of the present invention is an impact tool which applies a torque and an impact force to a tip tool, and the impact tool includes: a motor; a spindle rotated by the motor; an anvil to which the tip tool is attached; and a hammer which converts a torque of the spindle into a torque and an impact force of the anvil. The hammer includes: a second pawl to be engaged with a first pawl of the anvil; a through-hole through which the spindle passes; a plurality of cam grooves hollowed toward a radially outer side of the through-hole; a wall portion provided between the plurality of cam grooves in a circumferential direction of the through-hole; and a bottom portion positioned at a center portion of the cam groove in the circumferential direction of the through-hole. The second pawl is provided between the bottom portion and the wall portion in the circumferential direction of the through-hole.

In another aspect of the present invention, a top portion of the second pawl provided in a center portion in the circumferential direction on a radially inner side is positioned between the bottom portion and the wall portion.

In another aspect of the present invention, a plurality of the second pawls are provided, and at least one of the plurality of second pawls is provided between the bottom portion and the wall portion.

In another aspect of the present invention, each number of the first pawls and the second pawls is three.

Another aspect of the present invention is an impact tool which applies a torque and an impact force to a tip tool, and the impact tool includes: a motor; a spindle rotated by the motor; an anvil to which the tip tool is attached; and a hammer which converts a torque of the spindle into a torque and an impact force of the anvil. The hammer includes: a second pawl to be engaged with a first pawl of the anvil; a through-hole through which the spindle passes; a plurality of cam grooves hollowed toward a radially outer side of the through-hole; a wall portion provided between the plurality of cam grooves in a circumferential direction of the through-hole; and a bottom portion positioned at a center portion of the cam groove in the circumferential direction of the through-hole. A center portion of the second pawl in the circumferential direction is positioned to be shifted from the bottom portion and the wall portion in the circumferential direction.

In another aspect of the present invention, a plurality of the second pawls are provided, the center portion of at least one of the plurality of second pawls in the circumferential direction is positioned within a region of one of the inclined portions, and the spindle is pushed against the other of the inclined portions when the first pawl and the second pawl are engaged with each other. In another aspect of the present invention, each number of the first pawls and the second pawls is three.

Another aspect of the present invention is an impact tool which applies a torque and an impact force to a tip tool, and the impact tool includes: a motor; a spindle rotated by the motor; an anvil which includes a first pawl and to which the tip tool is attached on a front side; and a hammer which is provided on a rear side of the anvil and having a second pawl which is engaged with the first pawl and a cam groove whose front side is opened, whose rear side has a bottom portion, and which holds a steel ball together with the spindle, and converting a torque of the spindle into a torque and an impact force of the anvil. It is configured such that the first pawl overlaps the bottom portion of the cam groove when viewed from a shaft direction of the spindle in a state the first pawl and the second pawl are engaged with each other.

In another aspect of the present invention, a plurality of the first pawls are provided, and at least one of the plurality of first pawls overlaps the bottom portion.

In another aspect of the present invention, the first pawl overlaps the steel ball when viewed from a shaft direction of the rotating member in a state in which the first pawl and the second pawl are engaged with each other.

In another aspect of the present invention, each number of the first pawls and the second pawls is three.

### Effects of the Invention

According to the present invention, even when the gouging force acts on the impact tool, the galling phenomenon between the impact member and the rotating member can be suppressed, so that a stable operation of the impact tool can be achieved over a long period of time.

According to the present invention, when a first pawl and a second pawl are engaged with each other and perform an impact operation, the leakage of the grease adhering to the steel ball to the outside can be suppressed. Accordingly, the stable operation of the impact tool can be achieved over a long period of time.

### BRIEF DESCRIPTIONS OF THE DRAWINGS

FIG. 1 is a perspective view illustrating an impact tool of the present invention;

FIG. 2 is a partial cross-sectional view of the impact tool of FIG. 1;

FIG. 3 is an exploded perspective view of an impact mechanism of a first embodiment;

FIG. 4(a) is a perspective view of a hammer and FIG. 4(b) is a development view of a through-hole;

FIG. 5 is an enlarged cross-sectional view for describing a backward operation of the hammer;

FIGS. 6(a) and 6(b) are explanatory diagrams of operations when the impact mechanism of FIG. 3 is viewed from the shaft direction;

FIG. 7 is a diagram illustrating an impact mechanism of a second embodiment, which corresponds to FIG. 3;

FIGS. 8(a) to 8(c) are explanatory diagrams of operations when the impact mechanism of FIG. 7 is viewed from the shaft direction;

FIGS. 9(a) to 9(c) are explanatory diagrams of operations when an impact mechanism of a third embodiment is viewed from the shaft direction;

FIG. 10 is a development view of a through-hole of a hammer of a fourth embodiment;

FIGS. 11(a) and 11(b) are explanatory diagrams of operations when an impact mechanism, obtained by applying the hammer of FIG. 10 into the impact mechanism of FIG. 3, is viewed from the shaft direction;

FIGS. 12(a) and 12(b) are views illustrating an impact mechanism of a fifth embodiment, which are corresponding views of FIGS. 11(a) and 11(b);

FIG. 13 is an exploded perspective view of an impact mechanism of a sixth embodiment;

FIGS. 14(a) and 14(b) are explanatory diagrams of operations when the impact mechanism of FIG. 13 is viewed from the shaft direction;

FIGS. 15(a) and 15(b) are views illustrating an impact mechanism of a seventh embodiment, which are corresponding views of FIGS. 11(a) and 11(b);

FIG. 16 is an explanatory diagram for describing a positional relation between a hammer pawl and an anvil pawl of a conventional impact tool;

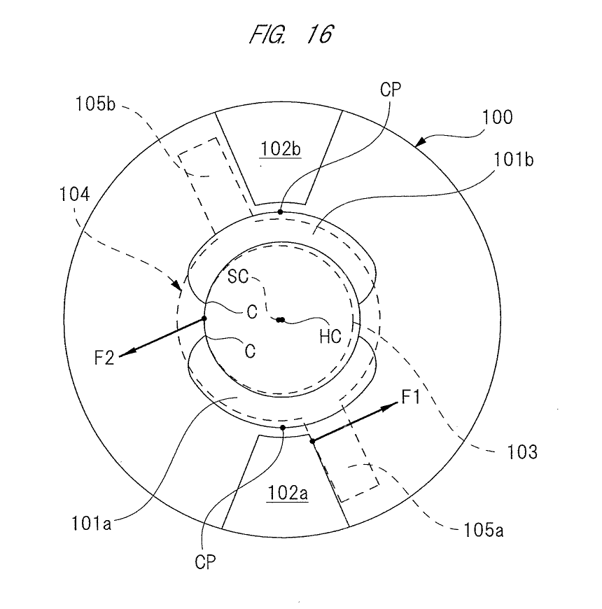

FIG. 17 is an explanatory diagram for describing a positional relation between the hammer pawl and the anvil pawl of the conventional impact tool; and

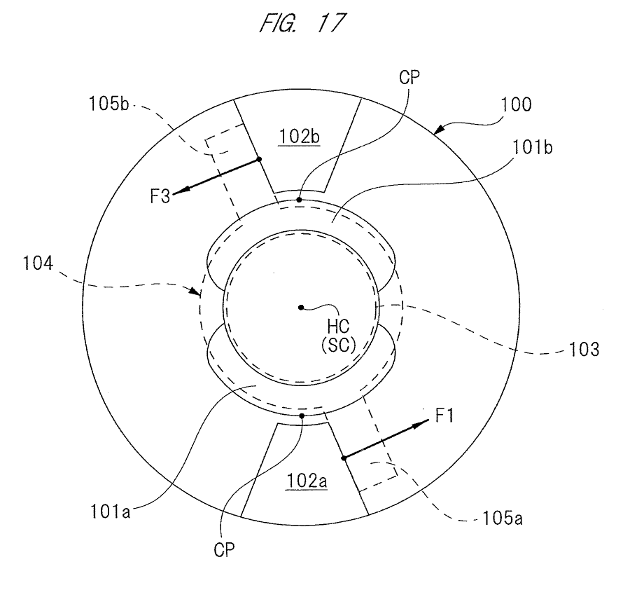

FIG. 18 is a diagram obtained by viewing the conventional impact mechanism from the shaft direction.

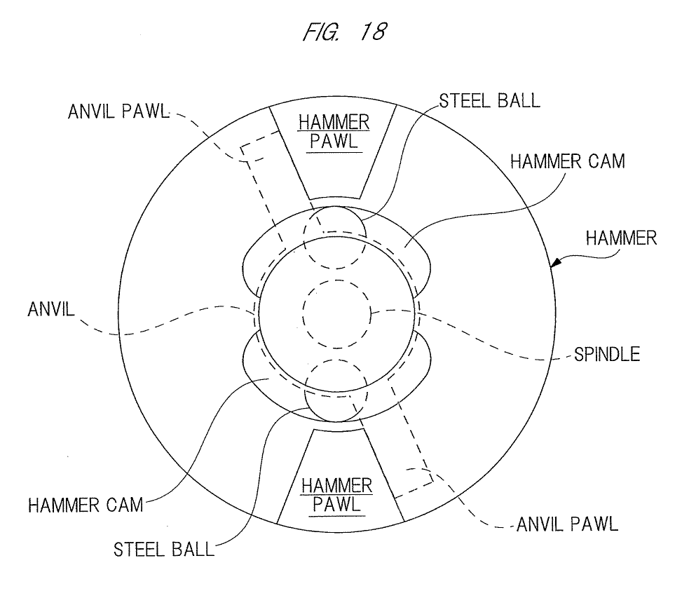

### DETAILED DESCRIPTION OF PREFERRED EMBODIMENTS

Hereinafter, a first embodiment of the present invention will be described in detail with reference to the drawings.

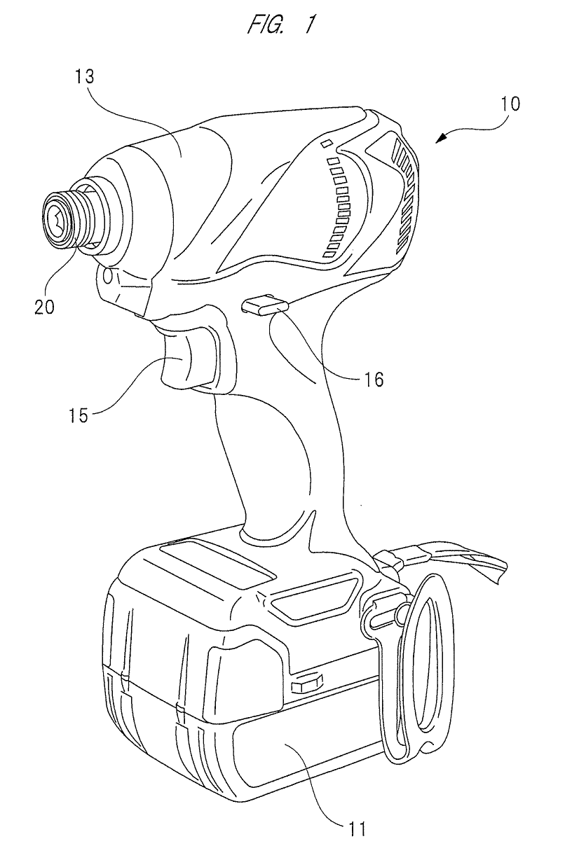

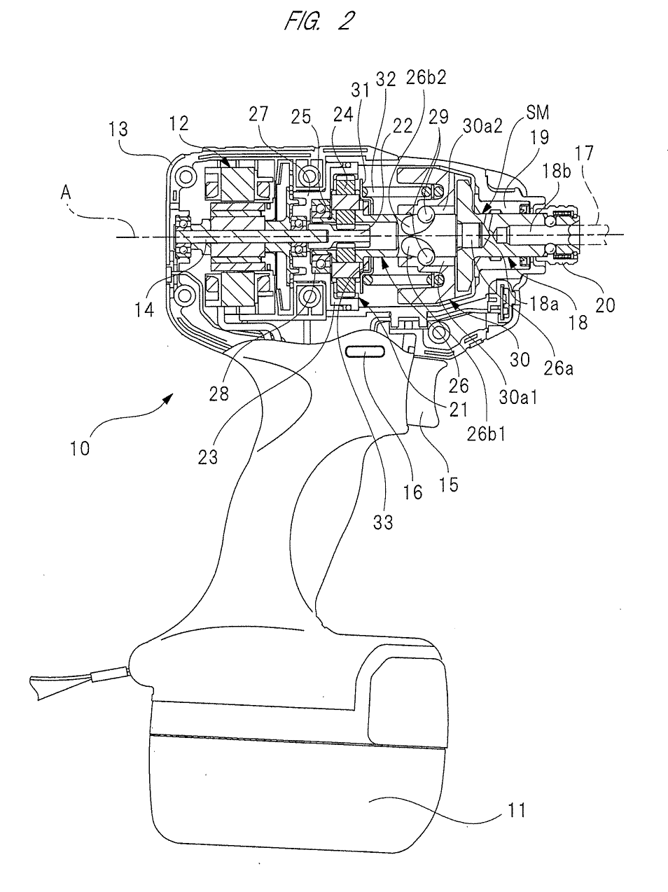

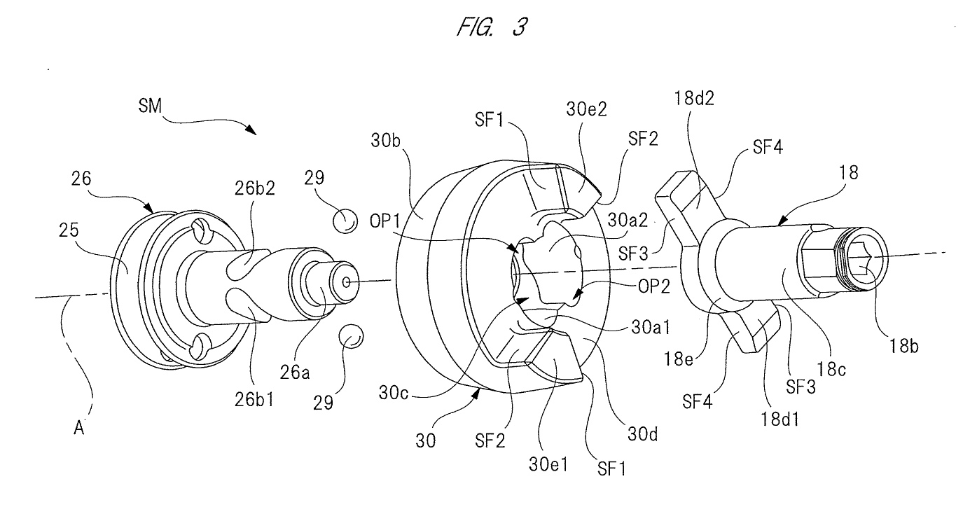

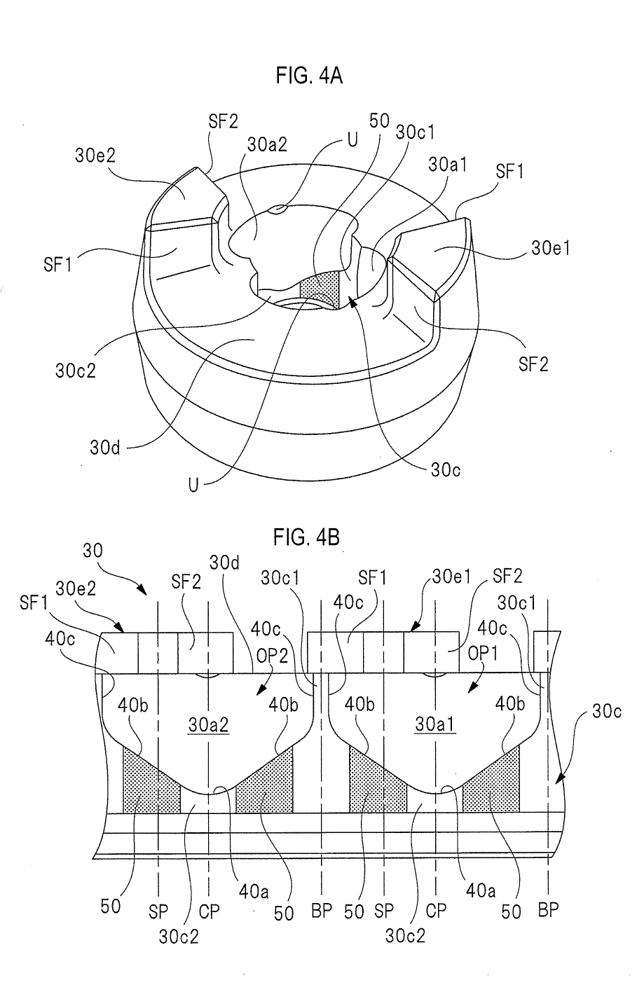

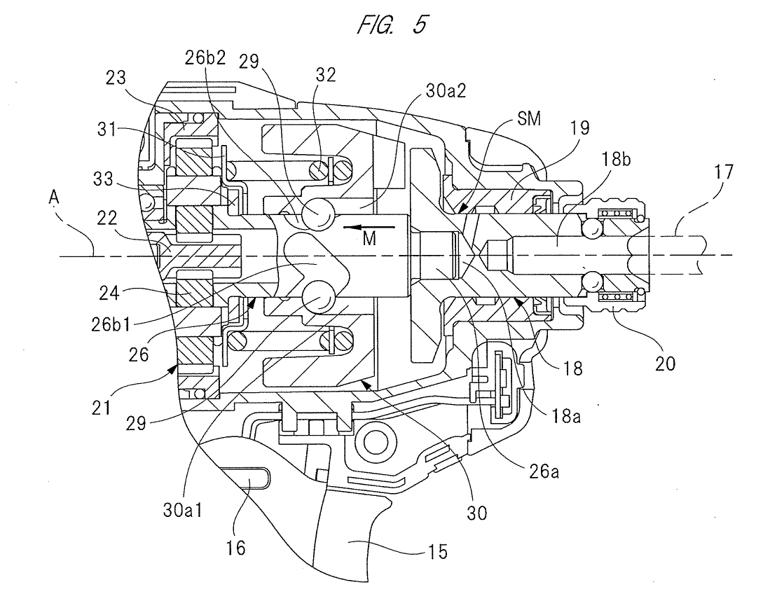

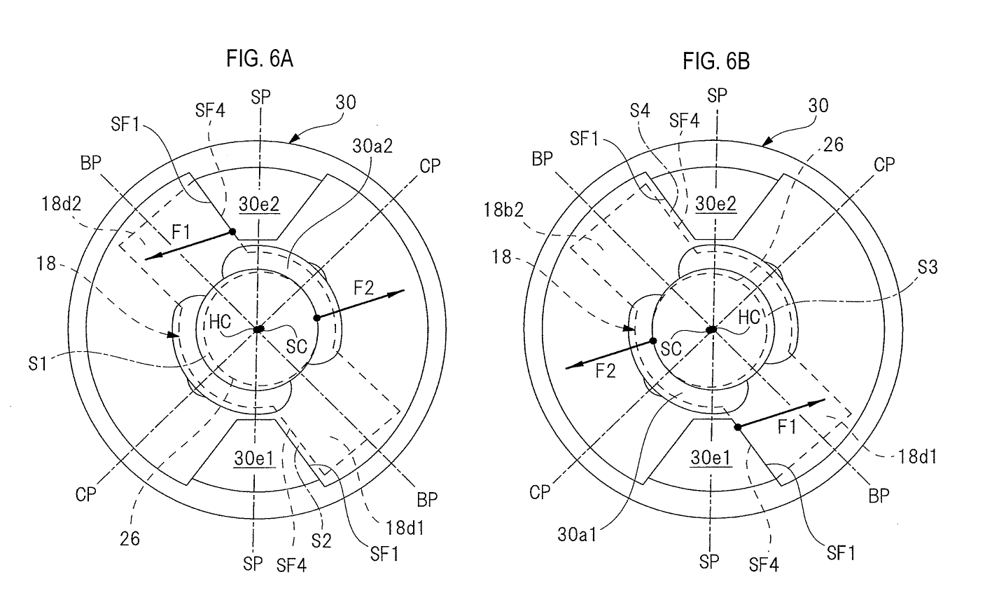

FIG. 1 is a perspective view illustrating an impact tool of the present invention, FIG. 2 is a partial cross-sectional view of the impact tool of FIG. 1, FIG. 3 is an exploded perspective view of an impact mechanism of a first embodiment, FIG. 4(a) is a perspective view of a hammer, FIG. 4(b) is a development view of a through-hole, FIG. 5 is an enlarged cross-sectional view for describing a backward operation of the hammer, and FIGS. 6(a) and 6(b) are explanatory diagrams of operations when the impact mechanism of FIG. 3 is viewed from the shaft direction.

As illustrated in FIGS. 1 and 2, an impact driver 10 serving as the impact tool is provided with a battery pack 11 in which a chargeable/dischargeable battery cell is housed and with an electric motor 12 which is driven by power supplied from the battery pack 11. The electric motor 12 is a driving source that converts electric energy into kinetic energy. The impact driver 10 is provided with a casing 13 made of plastic or others, and the electric motor 12 is provided inside the casing (housing) 13.

The electric motor 12 is provided with a rotation shaft 14 which rotates about a shaft A. The rotation shaft 14 rotates in a forward direction or a reverse direction through an operation of a trigger switch 15. That is, power is supplied from the battery pack 11 to the electric motor 12 through an operation of the trigger switch 15. Note that the rotation direction of the rotation shaft 14 is switched by operating a forward and reverse switching lever 16 provided in the vicinity of the trigger switch 15.

The impact driver 10 is provided with an anvil (output member) 18 whose distal end side (front side) supports a tip tool 17 such as a driver bit. The anvil 18 is supported by a sleeve 19 mounted inside the casing (hammer case) 13 so as to be freely rotatable. Note that the inside of the sleeve 19 is coated with grease (not illustrated) that makes the rotation of the anvil 18 smooth. Further, the anvil 18 rotates about the shaft A, and the tip tool 17 is provided in a distal end portion of the anvil 18 via a detachable mechanism 20 so as to be freely attachable.

A decelerator 21 is provided in a portion inside the casing (hammer case) 13, the portion being between the electric motor 12 and the anvil 18 in a direction and along the shaft A. The decelerator 21 is a power transmission device that transmits a torque of the electric motor 12 to the anvil 18, and the decelerator 21 is configured by a so-called single-pinion planetary gear mechanism. The decelerator 21 includes a sun gear 22 disposed coaxially with the rotation shaft 14, a ring gear 23 disposed so as to surround the sun gear 22, a plurality of planetary gears 24 meshing with both the sun gear 22 and the ring gear 23, and a carrier 25 which supports each of the planetary gears 24 so that the planetary gears can rotate and revolve. Further, the ring gear 23 is fixed to the casing (hammer case) 13 so that the ring gear cannot rotate.

A spindle (rotating member) 26, which rotates about the shaft A together with the carrier 25, is provided in the carrier 25 so as to be integrated with the carrier. That is, each of the rotation shaft 14 of the electric motor 12, the decelerator 21, the spindle 26, and the anvil 18 is disposed while having the shaft A as the center thereof. The spindle 26 is provided between the anvil 18 and the decelerator 21 in the direction along the shaft A, and a shaft 26a, which protrudes in the direction along the shaft A, is formed in a distal end portion of the spindle 26, the distal end portion being closer to the anvil 18.

A holder member 27, formed in a substantially bowl shape, is provided in a portion inside the casing (housing) 13, the portion being between the electric motor 12 and the decelerator 21 in the direction along the shaft A. A bearing 28 is mounted to a center portion of the holder member 27, and the bearing 28 supports a proximal end portion of the spindle 26, the proximal end portion being closer to the electric motor 12, so as to be freely rotatable. In addition, a pair of (two) groove-shaped spindle cams 26b1 and 26b2 is provided in an outer circumferential portion of the spindle 26, the outer circumferential portion being closer to the anvil 18. Into each of the spindle cams 26b1 and 26b2, a substantially half of a steel ball 29 enters. Note that the spindle cams 26b1 and 26b2 are also coated with grease (not illustrated) in order to make the roll of the steel ball 29 smooth. That is, the casing 13 (space formed by the hammer case and the holder member 27), which houses a later-described hammer 30, is filled with the grease serving as the lubricant.

A proximal end portion of the anvil 18, the proximal end portion being closer to the spindle 26, is provided with a holding hole 18a disposed coaxially with the shaft A. Into the holding hole 18a, the shaft 26a of the spindle 26 is inserted so as to be freely rotatable. That is, the anvil 18 and the spindle 26 rotate in relative to each other about the shaft A. Note that a portion between the shaft 26a and the holding hole 18a is also coated with a grease (not illustrated) in order to make the relative rotation between them smooth. In addition, an attachment hole 18b is provided in the anvil 18 so as to be coaxial with the shaft A. The attachment hole 18b is opened toward the outside of the casing (hammer case) 13 and is provided so that a proximal end portion of the tip tool 17 is attached and detached.

The hammer (impact member) 30 formed in a substantially annular shape is provided around the spindle 26. The hammer 30 is disposed in a portion between the decelerator 21 and the anvil 18 (the portion being closer to a rear side of the anvil 18) in the direction along the shaft A. The hammer 30 can rotate in relative to the spindle 26 and can move in relative to the direction along the shaft A. Note that FIG. 2 illustrates a state in which the hammer 30 is moved to be the closest to the front side (to the anvil 18). At this time, the steel ball 29 to be described later is positioned at a bottom portion of hammer cams 30a1 and 30a2 described later, the bottom portion being the closest to the rear side (to an opposite side of the anvil 18) in the direction along the shaft A. A pair of (two) groove-shaped hammer cams (cam grooves) 30a1 and 30a2 extending in the direction along the shaft A is formed in an inner circumferential portion of the hammer 30. Inside each of the hammer cams 30a1 and 30a2, a substantially half of the steel ball 29 enters. Note that the hammer cams 30a1 and 30a2 are also coated with grease (not illustrated) in order to make the roll of the steel ball 29 smooth.

In this manner, one of the steel balls 29 is held by the spindle cam 26b1 and the hammer cam 30a1 which are paired. In addition, the other of the steel balls 29 is held by the spindle cam 26b2 and the hammer cam 30a2 which are paired. Here, the steel ball 29 is configured by a metallic rolling body. Thus, the hammer 30 is movable in the direction along the shaft A within a range in which the steel ball 29 can roll in relative to the spindle 26. In addition, the hammer 30 is movable in the circumferential direction taking the shaft A as a center within a range in which the steel ball 29 can roll in relative to the spindle 26.

An annular plate 31 made of a steel plate is provided around the spindle 26 between the decelerator 21 and the hammer 30 in the direction along the shaft A. In addition, the spring 32 is provided so as to be compressed between the annular plate 31 and the hammer 30 in the direction along the shaft A. The movement of the carrier 25 in the direction along the shaft A is regulated as being in contact with the bearing 28 and the holder member 27, and a pressing force of the coil spring 32 is applied to the hammer 30. Accordingly, the hammer 30 is pressed toward the anvil 18 in the direction along the shaft A by the pressing force of the coil spring 32.

An annular stopper 33 is provided around the spindle 26 inside the annular plate 31 in the radial direction. The stopper 33 is formed of an elastic body such as rubber and is attached to the spindle 26. Further, the stopper 33 regulates the amount of movement of the hammer 30 toward the decelerator 21 along the shaft A.

Here, an impact mechanism SM, which applies an impact force to the tip tool 17, is formed of the spindle 26, the hammer 30, the anvil 18, the steel ball 29, and the coil spring 32. Further, when a load in the rotation direction of the anvil 18 increases, second pawls 30e1 and 30e2 (hammer pawls) of the hammer 30 and first pawls 18d1 and 18d2 (anvil pawls) of the anvil 18 (see FIG. 3 for all pawls) are repeatedly opened from and engaged with each other at high speed, so that an impact force is generated at the tip tool 17. Here, the weight of the hammer 30 is set to be larger than the weight of the anvil 18, and the hammer 30 transmits the torque of the spindle 26 to the anvil 18 and converts the torque of the spindle 26 into the impact force of the anvil 18 in the rotation direction. However, the weight of the hammer 30 may be set to be smaller than the weight of the anvil 18.

Next, the engagement structure between the hammer 30 and the anvil 18 will be described in detail with reference to FIGS. 3 to 5.

The hammer 30 is provided with a main body 30b formed in a substantially cylindrical shape. Inside the main body 30b in the radial direction, a through-hole 30c, which extends in the direction along the shaft A and through which the spindle 26 passes to be freely rotatable, is provided. A portion of the main body 30b, the portion being closer to the anvil 18, is gradually thinned. That is, a portion of the main body 30b, the portion being closer to the spindle 26, has a large diameter, and a portion of the main body 30b, the portion being closer to the anvil 18, has a small diameter. Here, a diameter size of the portion of the main body 30b, the portion being closer to the spindle 26 (the large diameter portion), is set to be about 40 mm.

A portion of the main body 30b, the portion being closer to the anvil 18, has an opposed plane 30d opposing the anvil 18. The opposed plane 30 is provided integrally with the two second pawls 30e1 and 30e2 which protrude toward the anvil 18 in the direction along the shaft A. These second pawls 30e1 and 30e2 are disposed at an interval of 180 degrees in the circumferential direction of the opposed plane 30d, and each has a substantially circular sector cross-sectional shape along a direction intersecting the shaft. Further, the gradually-thinned distal end portion of the second pawls 30e1 and 30e2, that is, an inside portion of the circular sector shape in the radial direction is directed toward the radially inner side of the hammer 30, that is, toward the through-hole 30c.

A first contact plane SF1 is provided on one of the second pawls 30e1 and 30e2 in the circumferential direction of the hammer 30. In addition, a second contact plane SF2 is provided on the other of the second pawls 30e1 and 30e2 in the circumferential direction of the hammer 30. Further, a later-described substantially entire fourth contact plane SF4 of each of the first pawls 18d1 and 18d2 of the anvil 18 is in contact with of the first contact plane SF1, and a substantially entire third contact plane SF3 of each of the first pawls 18d1 and 18d2 of the anvil 18 is in contact with the second contact plane SF2.

In addition, each width size of the second pawls 30e1 and 30e2 positioned on an outer side of the hammer 30 in the radial direction and formed in the circumferential direction is set to be about 15 mm. Accordingly, each of the first pawls 18d1 and 18d2 of the anvil 18 enters between the second pawls 30e1 and 30e2 of the hammer 30 which are adjacent to each other in the circumferential direction with a sufficient margin.

The pair of hammer cams (cam grooves) 30a1 and 30a2 is provided in the inner circumferential portion of the hammer 30, that is, the through-hole 30c so as to oppose each other while taking the through-hole 30c as the center thereof. The hammer cams 30a1 and 30a2 are hollowed toward the radially outer side from the through-hole 30c, and each depth size of the hammer cams 30a1 and 30a2 in the radial direction is substantially equal to a radius size of the steel ball 29. When each of the hammer cams 30a1 and 30a2 is viewed from the radially inner side of the through-hole 30c, each of them is formed in a substantially U shape as illustrated in FIG. 4(b).

Both of the hammer cams 30a1 and 30a2 are formed in the same shape as each other, and a circular arc portion 40a is provided in each center portion CP of the hammer cams 30a1 and 30a2 in the circumferential direction of the through-hole 30c. A position of the center of the circular arc portion 40a in the circumferential direction (the center being in a bottom portion of the cam groove and being a top portion of the hammer cam) substantially matches a position of the center portion CP. That is, the center portion CP of each of the hammer cams 30a1 and 30a2 in the circumferential direction substantially matches the rearmost end (the lowest portion inside the hammer cam in FIG. 4(b)) of each of the hammer cams 30a1 and 30a2 in the shaft direction of the through-hole 30c. The circular arc portion 40a is disposed in a portion of the hammer 30, the portion being closer to the decelerator 21 in the shaft direction (the lower side of the drawing). In addition, an inclined portion 40b, which extends toward the anvil 18 (the upper side of the drawing) in the shaft direction of the hammer 30, is provided in each of both sides of the circular arc portion 40a in the circumferential direction of the through-hole 30c. Further, a linear portions 40c, which extends in the shaft direction of the hammer 30 (through-hole 30c), is provided on the opposite side of the circular arc portion 40a from each of the inclined portions 40b. Here, during the operation of the impact driver 10, when the steel balls 29 move in the respective hammer cams 30a1 and 30a2 so that the first pawls 18d1 and 18d2 and the second pawls 30e1 and 30e2 are engaged with each other, each of the steel balls 29 is positioned at each of the circular arc portions 40a.

A wall portion 30c1, which has a large size in the shaft direction of the through-hole 30c, that is, which is not hollowed from the through-hole 30c toward the radially outer side, is provided in a portion between the hammer cams 30a1 and 30a2 in the circumferential direction of the through-hole 30c, the portion corresponding to the linear portion 40c. The wall portions 30c1 are provided at two positions shifted by about 180 degrees from each other in the circumferential direction of the through-hole 30c and have functions of partitioning the two hammer cams 30a1 and 30a2. In addition, a bottom portion 30c2 having a smaller size in the shaft direction of the through-hole 30c is provided in a portion having the center portion CP (the top portion of the hammer cam) of each of the hammer cams 30a1 and 30a2 in the circumferential direction of the through-hole 30c, the portion corresponding to the circular arc portion 40a. The bottom portions 30c2 are provided at two positions shifted by about 180 degrees from each other in the circumferential direction of the through-hole 30c.

Here, a size of the bottom portion 30c2 in the shaft direction of the through-hole 30c is set to be a size which is about 1/7 of a size of the wall portion 30c1 in the shaft direction of the through-hole 30c. Meanwhile, a width size of the bottom portion 30c2 in the circumferential direction of the through-hole 30c is set to be a size which is substantially the same as a width size of the wall portion 30c1 in the circumferential direction of the through-hole 30c on one end side (closer to the decelerator 21) of the through-hole 30c in the shaft direction. In addition, a width size of the wall portion 30c1 in the circumferential direction of the through-hole 30c on the other end side (closer to the anvil 18) of the through-hole 30c in the shaft direction is set to be a size which is about ¼ of a width size of the bottom portion 30c2 in the circumferential direction of the through-hole 30c. Here, a reference character BP in FIG. 4(b) represents a center portion of the wall portion 30c1 in the circumferential direction of the through-hole 30c.

An inclined portion (trapezoid-shaped portion) 50 (the shaded portion in the drawing) which is formed in a substantially trapezoidal shape is formed in a portion which is between the wall portion 30c1 and the bottom portion 30c2 in the circumferential direction of the through-hole 30c to connect the wall portion 30c1 and the bottom portion 30c2, the portion corresponding to the inclined portion 40b. The inclined portion 50 is provided at two positions (four positions in total) which are symmetric to each other with respect to the center portion CP (the top portion of the hammer cam) of each of the hammer cams 30a1 and 30a2 in the circumferential direction of the through-hole 30c. That is, each of the hammer cams 30a1 and 30a2 is configured by sequentially providing the wall portion 30c1, the inclined portion 50, the bottom portion 30c2, the inclined portion 50, and the wall portion 30c1 in the circumferential direction of the through-hole 30c. In other words, the bottom portions 30c2, the inclined portions 50, and the wall portions 30c1 are provided in this order from the center portion CP so as to be symmetric with each other with respect to the center portion CP of each of the hammer cams 30a1 and 30a2 (the top portion of the hammer cam). In addition, the inclined portion 50 functions as a pressing portion (the shaded portion in the drawing) against which the outer circumferential portion of the spindle 26 is pushed when the first pawls 18d1 and 18d2 of the anvil 18 and the second pawls 30e1 and 30e2 of the hammer 30 are engaged with (impact) each other. In other words, the spindle 26 is pushed against the inclined portion 50 when either one of the first pawls 18d1 and 18d2 and either one of the second pawls 30e1 and 30e2 are engaged with each other in an uneven contact state. A size of the inclined portion 50 in the shaft direction of the through-hole 30c is smaller than a size of the wall portion 30c1 in the shaft direction of the through-hole 30c but larger than a size of the bottom portion 30c2 in the shaft direction of the through-hole 30c. Here, when a surface area of the bottom portion 30c2 and a surface area of the inclined portion 50 are compared with each other, the surface area of the inclined portion 50 is set to be larger. This means that the inclined portion 50 can disperse a load applied from the spindle 26 more than the bottom portion 30c2. That is, the inclined portion 50 can reduce a surface pressure per unit area more than the bottom portion 30c2.

On the other hand, when a surface area of the wall portion 30c1 and a surface area of the inclined portion 50 are compared with each other, the surface area of the inclined portion 50 is set to be smaller, and the wall portion 30c1 is provided with the linear portion 40c in the shaft direction of the through-hole 30c. The linear portion 40c is orthogonal to a rotation direction of the spindle 26 with respect to the hammer 30, and the linear portion 40c functions as a corner portion with which the spindle 26 can be in line contact. That is, when the gouging force acts on the impact driver 10 so that the linear portion 40c and the spindle 26 are in line contact with each other, a surface pressure in the contact portion increases, a large load is applied to the corner portion, and accordingly, there is a risk of occurrence of the galling phenomenon.

Therefore, in order to suppress the occurrence of the galling phenomenon between the spindle 26 and the hammer 30, it is desirable to push the outer circumferential portion of the spindle 26 against the inclined portion 50 (portion having a large contact area) when the gouging force acts on the impact driver 10. Thus, in the present invention, the positions of the second pawls 30e1 and 30e2 in the circumferential direction of the hammer 30 and the positions of the hammer cams 30a1 and 30a2 in the circumferential direction of the through-hole 30c are set to have a positional relation in which the outer circumferential portion of the spindle 26 is pushed against the inclined portion 50, that is, a positional relation in which the hammer 30 and the spindle 26 can be in contact with each other in the inclined portion 50.

Specifically, the second pawls 30e1 and 30e2 are provided at positions shifted from the wall portion 30c1 and the bottom portion 30c2 in the circumferential direction of the hammer 30 so that each top portion SP of the second pawls 30e1 and 30e2 provided in the opposed planes 30d of the hammer 30 is within a range (within a shaded range in the drawing) of the inclined portion (pressing portion) 50 in the circumferential direction of the through-hole 30c. That is, in focusing on the hammer cam 30a1, when the top portion SP of the second pawl 30e1 is within the range of one of the inclined portions 50 in the circumferential direction of the through-hole 30c, the spindle 26 is received by the other of the inclined portions 50. The inclined portion 50 (portion with which the spindle 26 is in contact) is provided at a position shifted from the top portion SP of the second pawl 30e1 by about 90 degrees in the circumferential direction of the through-hole 30c. The same goes for the hammer cam 30a2. Note that the top portion SP of each of the second pawls 30e1 and 30e2 is provided in a portion closer to the gradually-thinned distal end portion of each of the second pawls 30e1 and 30e2, the portion being at the center portion in the circumferential direction of the hammer 30.

Here, as illustrated in FIG. 4(a), the hammer cams 30a1 and 30a2 formed in the through-hole 30c of the hammer 30 are opened (as opening portions OP1 and OP2) in a portion closer to the opposed plane 30d of the hammer 30, that is, closer to the anvil 18. Each opening shape of the opening portions OP1 and OP2 of the hammer cams 30a1 and 30a2, the opening shape being on the opposed plane 30d, has a cross-section formed in a substantially arc shape. A hollowed portion U by which the steel ball 29 is easily embedded in each of the hammer cams 30a1 and 30a2 is provided in each opening portion (the opening portions OP1 and OP2) of the hammer cams 30a1 and 30a2.

As illustrated in FIG. 3, the anvil 18 is provided with a main body 18c formed in a substantially cylindrical shape. The two first pawls 18d1 and 18d2 protruding toward the radially outer side are integrally provided in a portion of the main body 18c, the portion being closer to the hammer 30 side in the shaft direction. These first pawls 18d1 and 18d2 are disposed at an interval of 180 degrees in the circumferential direction of the main body 18c, and each has a substantially rectangular cross-sectional shape along a direction intersecting the shaft A.

The third contact plane SF3 is provided on one side of each of the first pawls 18d1 and 18d2 in the circumferential direction of the anvil 18. In addition, the fourth contact plane SF4 is provided on the other side of each of the first pawls 18d1 and 18d2 in the circumferential direction of the anvil 18. Further, the third contact plane SF3 is in contact with of the substantially entire second contact plane SF2 of each of the second pawls 30e1 and 30e2 of the hammer 30, and the fourth contact plane SF4 is in contact with the substantially entire first contact plane SF1 of each of the second pawls 30e1 and 30e2 of the hammer 30.

In addition, each width size of the first pawls 18d1 and 18d2 of the anvil 18 positioned on the radially outer side in the circumferential direction thereof is set to be about 15 mm. That is, each width size of the first pawls 18d1 and 18d2 is set to be substantially the same width size as each of the second pawls 30e1 and 30e2 of the hammer 30. Accordingly, each of the second pawls 30e1 and 30e2 of the hammer 30 enters between the adjacent first pawls 18d1 and 18d2 of the anvil 18 in the circumferential direction with a sufficient margin.

Next, an operation of the impact driver 10 will be described in detail with reference to the drawings.

When the electric motor 12 is stopped, the hammer 30 pressed by the coil spring 32 is in contact with the anvil 18 and stops. When the rotation shaft 14 is rotated by supply of power to the electric motor 12, the torque of the rotation shaft 14 is transmitted to the sun gear 22 of the decelerator 21. When the torque is transmitted to the sun gear 22, the ring gear 23 serves as a reaction force element, and the carrier 25 serves as an output element. That is, the torque of the sun gear 22 is transmitted to the carrier 25, and a rotational speed of the carrier 25 becomes lower than a rotational speed of the sun gear 22, so that the torque is amplified.

When the torque is transmitted to the carrier 25, the spindle 26 rotates together with the carrier 25. The torque of the spindle 26 is transmitted to the hammer 30 via the steel ball 29. The torque of the hammer 30 is transmitted to the anvil 18 through each engagement between the second pawls 30e1 and 30e2 and the first pawls 18d1 and 18d2, and accordingly, the anvil 18 is rotated. The torque transmitted to the anvil 18 is transmitted to a screw (not illustrated) via the tip tool 17, and the screw is screwed into a target object such as wood.

A state in which the torque required for rotation of the tip tool 17 is small, that is, a low-load state is a state in which the first contact planes SF1 of the second pawls 30e1 and 30e2 and the fourth contact planes SF4 of the first pawls 18d1 and 18d2 are in contact with each other. Then, when the screw is screwed into the wood to increase the torque required for the rotation of the tip tool 17 due to an increase of frictional resistance between the wood and the screw or others, the anvil 18 stops. Accordingly, the steel ball 29 rolls inside the hammer cams 30a1 and 30a2 and the spindle cams 26b1 and 26b2, and accordingly moves along the shaft A so that the hammer 30 is away from the anvil 18, as illustrated with an arrow M in FIG. 5.

Here, as illustrated in FIG. 5, each of the spindle cams 26b1 and 26b2 is formed in a substantially V shape, and the V-shaped opening side thereof is directed toward the decelerator 21 (left in the drawing). Accordingly, the steel ball 29 rolls toward a portion of the spindle cams 26b1 and 26b2, the portion being closer to the decelerator 21, due to the relative rotation between the spindle 26 and the hammer 30, and therefore, the hammer 30 moves toward the decelerator 21 side against the spring force of the coil spring 32.

Accordingly, the second pawls 30e1 and 30e2 and the first pawls 18d1 and 18d2 are disengaged and released from each other, and the torque of the hammer 30 is not transmitted to the anvil 18. When the hammer 30 moves backward too much (is too away from the anvil 18), note that an end portion of the hammer 30, the end portion being closer to the electric motor 12 (closer to the decelerator 21), impacts the stopper 33, and therefore, the kinetic energy of the hammer 30 can be absorbed by the stopper 33.

Then, when the rotation of the hammer 30 is further continued so that the second pawls 30e1 and 30e2 ride over the first pawls 18d1 and 18d2, the steel ball 29 rolls inside the hammer cams 30a1 and 30a2 and the spindle cams 26b1 and 26b2 by the pressing force of the coil spring 32 against the hammer 30, so that the hammer 30 moves to approach the anvil 18 while rotating in relative thereto.

Then, the second pawls 30e1 and 30e2 of the rotating hammer 30 impact the first pawls 18d1 and 18d2 of the stopping anvil 18, an impact force is applied in the rotation direction of the anvil 18 and the tip tool 17, so that the screw can be tightened. Here, when the rotation direction of the electric motor 12 is reversed by an operation of the forward and reverse switching lever 16, the impact force can be applied in the reverse direction to that in the above-described operation. Accordingly, the tightened screw can be loosened.

Here, the gouging force acts on the rotation shaft of the impact driver 10 if the rotation shaft of the impact driver 10 and the rotation shaft of the screw do not match each other when the hammer 30 applies the impact force to the anvil 18, that is, when the impact mechanism SM is operated. Then, as illustrated in FIG. 6(a), the shaft center HC of the hammer 30 and the shaft center SC of the spindle 26 are misaligned to each other, and only the first contact plane SF1 of the second pawl 30e2 impacts (partially contacts) the fourth contact plane SF4 of the first pawl 18d2, so that the impact force F1 is generated. At this moment, because of the misalignment between the shaft center HC of the hammer 30 and the shaft center SC of the spindle 26, a gap S1 is formed between the hammer 30 and the spindle 26, and a gap S2 is formed between the second pawl 30e1 and the first pawl 18d1, so that the first contact plane SF1 of the second pawl 30e1 and the fourth contact plane SF4 of the first pawl 18d1 do not impact each other. Further, a reaction force F2 acting in the opposite direction of the impact force F1 acts on the spindle 26 in order to remove the gaps S1 and S2 at this moment, so that the spindle 26 is strongly pushed against the inclined portion (pressing portion) 50 (see the shaded portion of FIG. 4(b)) which is closer to the hammer cam 30a2 and which is between the wall portion 30c1 and the bottom portion 30c2 in the circumferential direction of the through-hole 30c. The impact force F1 and the reaction force F2 act on positions shifted from each other by about 90 degrees in the circumferential direction of the through-hole 30c.

In addition, depending on how to use the impact driver 10, the gouging force acts on a rotation shaft of the impact driver 10 as illustrated in FIG. 6(b) in some cases. In this case, only the first contact plane SF1 of the second pawl 30e1 impacts (partially contacts) the fourth contact plane SF4 of the first pawl 18d1, so that the impact force F1 is generated. At this moment, because of the misalignment between the shaft center HC of the hammer 30 and the shaft center SC of the spindle 26, a gap S3 is formed between the hammer 30 and the spindle 26, and a gap S4 is formed between the second pawl 30e2 and the first pawl 18d2, so that the first contact plane SF1 of the second pawl 30e2 and the fourth contact plane SF4 of the first pawl 18d2 do not impact each other. Further, the reaction force F2 acting in the opposite direction of the impact force F1 acts on the spindle 26, so that the spindle 26 is strongly pushed against the inclined portion (pressing portion) 50 (see the shaded portion of FIG. 4(b)) which is closer to the hammer cam 30a1 and which is between the wall portion 30c1 and the bottom portion 30c2 in the circumferential direction of the through-hole 30c.

As described above in detail, by the impact driver 10 according to the present embodiment, the inclined portion 50 is provided between the wall portion 30c1 which is provided between the pair of hammer cams 30a1 and 30a2 in the circumferential direction of the through-hole 30c and the bottom portion 30c2 which is provided in each center portion of the hammer cams 30a1 and 30a2 in the circumferential direction of the through-hole 30c, the inclined portion which has the smaller size than the size of the wall portion 30c1 in the shaft direction of the through-hole 30c and the larger size than the size of the bottom portion 30c2 in the shaft direction of the through-hole 30c and against which the spindle 26 is pushed when the first pawl 18d1 (18d2) and the second pawl 30e1 (30e2) are engaged with each other. That is, in order to make the spindle 26 contact one inclined portion 50 of one hammer cam, the positions of the second pawls 30e1 and 30e2 in the circumferential direction of the hammer 30 are disposed inside the region of the other inclined portion 50. The second pawl is disposed inside the region of the one inclined portion 50, and a contact portion (the other inclined portion) of the spindle 26 is disposed at a position shifted from the top portion SP of the second pawl by about 90 degrees in the circumferential direction of the hammer 30.

Accordingly, even when the gouging force acts on the impact driver 10, the spindle 26 is not pushed against the bottom portion 30c2 having the smallest surface area (contact area) or the wall portion 30c1 which includes the linear portion 40c functioning as the corner portion, and thus, the galling phenomenon between the hammer 30 and the spindle 26 is suppressed, so that a stable operation of the impact driver 10 can be achieved over a long period of time. Next, a second embodiment of the present invention will be described in detail with reference to the drawings. Note that portions having the same functions as those of the above-described first embodiment will be denoted by the same reference signs, and the detailed description thereof will be omitted.

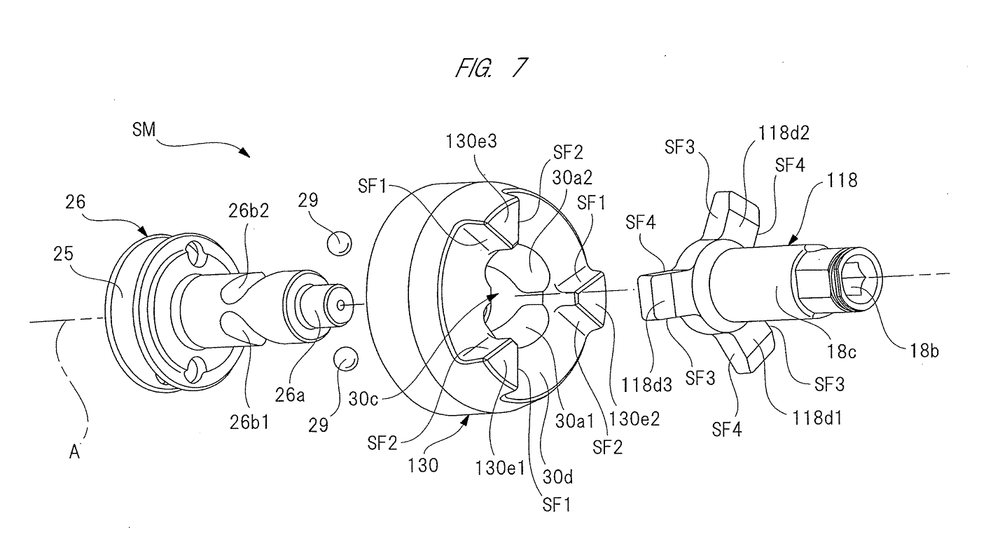

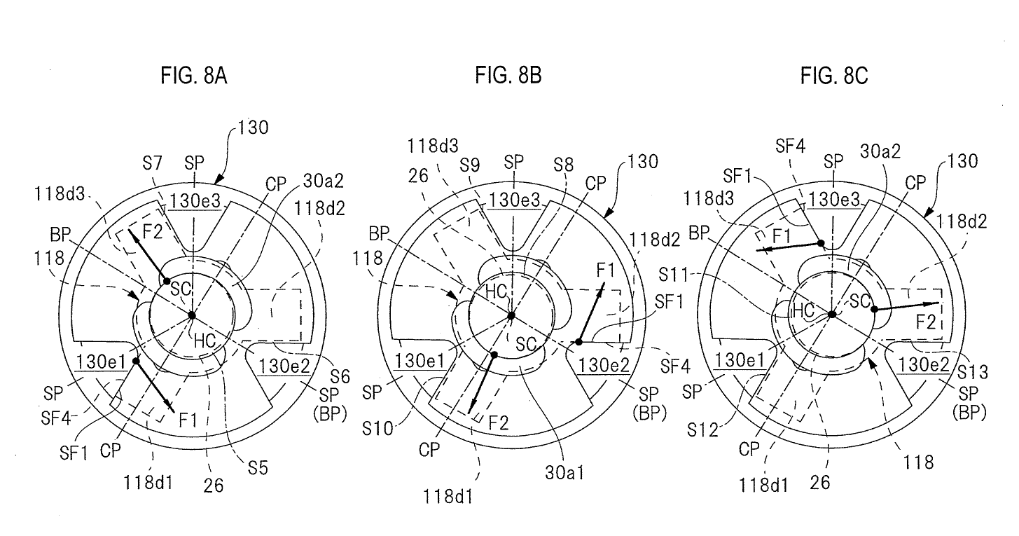

FIG. 7 is a diagram illustrating an impact mechanism of the second embodiment, which corresponds to FIG. 3, and each of FIGS. 8(a), 8(b), and 8(c) is an explanatory diagram of an operation performed when the impact mechanism of FIG. 7 is viewed from the shaft direction.

As illustrated in FIGS. 7 to 8, the second embodiment is different from the first embodiment in only a structure of the impact mechanism SM. A hammer (impact member) 130 of the impact mechanism SM of the second embodiment is provided with three second pawls 130e1, 130e2 and 130e3. These second pawls 130e1, 130e2 and 130e3 are disposed at an interval of 120 degrees in the circumferential direction of the opposed plane 30d, and each has a substantially circular sector cross-sectional shape in a direction intersecting the shaft A as similar to the first embodiment.

The first contact plane SF1 is provided on one side of each of the second pawls 130e1, 130e2 and 130e3 in the circumferential direction of the hammer 130. In addition, the second contact plane SF2 is provided on the other side of each of the second pawls 130e1, 130e2 and 130e3 in the circumferential direction of the hammer 130. Further, the substantially entire fourth contact plane SF4 of each of first pawls 118d1, 118d2 and 118d3 of an anvil (output member) 118 described later is in contact with the first contact plane SF1, and the substantially entire third contact plane SF3 of each of the first pawls 118d1, 118d2 and 118d3 of the anvil 118 is in contact with the second contact plane SF2.

In addition, each width size of the second pawls 130e1, 130e2, and 130e3 positioned on an outer side of the hammer 130 in the radial direction and formed in the circumferential direction is set to be about 10 mm. Accordingly, each of the first pawls 118d1, 118d2, and 118d3 of the anvil 118 enters among the second pawls 130e1, 130e2, and 130e3 of the hammer 130 which are adjacent to each other in the circumferential direction with a sufficient margin.

The three first pawls 118d1, 118d2 and 118d3 protruding toward the radially outer side are integrally provided in a portion of the main body 18c of the anvil 118, the portion being closer to the hammer 130 in the shaft direction. These first pawls 118d1, 118d2 and 118d3 are disposed at an interval of 120 degrees in the circumferential direction of the main body 18c, and each has a substantially rectangular cross-sectional shape in a direction intersecting the shaft A.

The third contact plane SF3 is provided on one side of each of the first pawls 118d1, 118d2 and 118d3 in the circumferential direction of the anvil 118. In addition, the fourth contact plane SF4 is provided on the other side of each of the first pawls 118d1, 118d2 and 118d3 in the circumferential direction of the anvil 118. Further, the substantially entire second contact plane SF2 of each of the second pawls 130e1, 130e2 and 130e3 of the hammer 130 is in contact with the third contact plane SF3, and the substantially entire first contact plane SF1 of each of the second pawls 130e1, 130e2 and 130e3 of the hammer 130 is in contact with the fourth contact plane SF4.

In addition, each width size of the first pawls 118d1, 118d2, and 118d3 positioned on an outer side of the anvil 118 in the radial direction and formed in the circumferential direction is set to be about 10 mm. That is, the width size is set to be substantially the same width size of each of the second pawls 130e1, 130e2, and 130e3 of the hammer 130. Accordingly, each of the second pawls 130e1, 130e2, and 130e3 of the hammer 130 enters among the first pawls 118d1, 118d2, and 118d3 of the anvil 118 which are adjacent to each other in the circumferential direction with a sufficient margin.

Here, positions of the two hammer cams 30a1 and 30a2 provided in the hammer 130 and positions of the three second pawls 130e1, 130e2 and 130e3 provided in the hammer 130 are set to have the following positional relation. That is, the two second pawls 130e1 and 130e3 among the three second pawls 130e1, 130e2 and 130e3 are provided at the positions shifted from the wall portion 30c1 and the bottom portion 30c2 (see FIG. 4(b)) in the circumferential direction of the hammer 130. That is, the top portion SP of each of the second pawls 130e1 and 130e3 is within the range of the inclined portion 50 (see the shaded portion of FIG. 4(b)) in the circumferential direction of the through-hole 30c. On the other hand, one second pawl 130e2 among the three second pawls 130e1, 130e2 and 130e3 is provided at a position of the wall portion 30c1 in the circumferential direction of the hammer 130.

And, when the gouging force acts on the rotation shaft of the impact driver 10, as illustrated in FIG. 8(a), the shaft center HC of the hammer 130 and the shaft center SC of the spindle 26 are misaligned to each other, and only the first contact plane SF1 of the second pawl 130e1 impacts (partially contacts) the fourth contact plane SF4 of the first pawl 118d1, so that the impact force F1 is generated. At this moment, because of the misalignment between the shaft center HC of the hammer 130 and the shaft center SC of the spindle 26, a gap S5 is formed between the hammer 130 and the spindle 26, a gap S6 is formed between the second pawl 130e2 and the first pawl 118d2, and a gap S7 is formed between the second pawl 130e3 and the first pawl 118d3. Further, a reaction force F2 acting in the opposite direction of the impact force F1 acts on the spindle 26, so that the spindle 26 is strongly pushed against the inclined portion (pressing portion) 50 (see the shaded portion of FIG. 4(b)) which is closer to the hammer cam 30a2 and which is between the wall portion 30c1 and the bottom portion 30c2 in the circumferential direction of the through-hole 30c.

FIG. 8(b) illustrates a case in which the shaft center HC of the hammer 130 and the shaft center SC of the spindle 26 are misaligned to each other, and only the first contact plane SF1 of the second pawl 130e2 impacts (partially contacts) the fourth contact plane SF4 of the first pawl 118d2, so that the impact force F1 is generated. At this moment, because of the misalignment between the shaft center HC of the hammer 130 and the shaft center SC of the spindle 26, a gap S8 is formed between the hammer 130 and the spindle 26, a gap S9 is formed between the second pawl 130e3 and the first pawl 118d3, and a gap S10 is formed between the second pawl 130e1 and the first pawl 118d1. Further, a reaction force F2 acting in the opposite direction of the impact force F1 acts on the spindle 26, so that the spindle 26 is strongly pushed against the bottom portion 30c2 (see the shaded portion of FIG. 4(b)) which is closer to the hammer cam 30a1 and which is in the circumferential direction of the through-hole 30c.

Here, the spindle 26 is pushed against the bottom portion 30c2 in the case of FIG. 8(b). However, this pattern is one of three patterns as illustrated in FIGS. 8(a), 8(b), and 8(c), and the other two patterns are configured so that the spindle 26 is pushed against the inclined portion 50. Therefore, the galling phenomenon can be sufficiently suppressed more than the conventional technique.

FIG. 8(c) illustrates a case in which the shaft center HC of the hammer 130 and the shaft center SC of the spindle 26 are misaligned to each other, and only the first contact plane SF1 of the second pawl 130e3 impacts (partially contacts) the fourth contact plane SF4 of the first pawl 118d3, so that the impact force F1 is generated. At this moment, because of the misalignment between the shaft center HC of the hammer 130 and the shaft center SC of the spindle 26, a gap S11 is formed between the hammer 130 and the spindle 26, a gap S12 is formed between the second pawl 130e1 and the first pawl 118d1, and a gap S13 is formed between the second pawl 130e2 and the first pawl 118d2. Further, a reaction force F2 acting in the opposite direction of the impact force F1 acts on the spindle 26, so that the spindle 26 is strongly pushed against the inclined portion 50 (see the shaded portion of FIG. 4(b)) which is closer to the hammer cam 30a2 and which is between the wall portion 30c1 and the bottom portion 30c2 in the circumferential direction of the through-hole 30c.

The second embodiment formed as described above also has the same functional effects as those of the above-described first embodiment. In addition, in the second embodiment, an impact efficiency can be improved because the three first pawls and the three second pawls are provided, so that work time or others can be shortened.

Next, a third embodiment of the present invention will be described in detail with reference to the drawings. Note that portions having the same functions as those of the above-described second embodiment will be denoted by the same reference signs, and the detailed description thereof will be omitted.

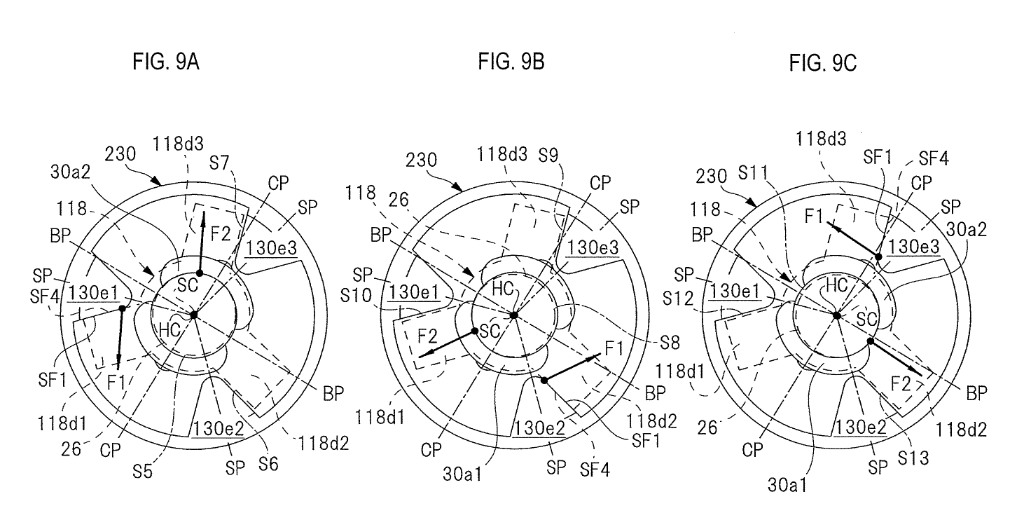

FIGS. 9(a), 9(b), and 9(c) illustrate explanatory diagrams of operations obtained when an impact mechanism of the third embodiment is viewed from the shaft direction.

As illustrated in FIG. 9, the third embodiment is slightly different from the second embodiment in a relation between positions of two hammer cams 30a1 and 30a2 provided in a hammer (impact member) 230 and positions of three second pawls 130e1, 130e2 and 130e3 provided in a hammer 230. Specifically, all the three second pawls 130e1, 130e2 and 130e3 are provided at the positions shifted from the wall portion 30c1 and the bottom portion 30c2 (see FIG. 4) in the circumferential direction of the hammer 230.

Further, also in the third embodiment, the number of patterns in which the spindle 26 is pushed against the hammer 230 is three as illustrated in FIGS. 9(a), 9(b), and 9(c). Here, the two patterns illustrated in FIGS. 9(a) and 9(b) are a pattern in which the spindle 26 is strongly pushed against each of the inclined portions 50 (see the shaded portion of FIG. 4(b)) between the wall portion 30c1 and the bottom portion 30c2 in the circumferential direction of the through-hole 30c. On the other hand, the pattern illustrated in FIG. 9(c) is a pattern in which the spindle 26 is strongly pushed against the wall portion 30c1 (see FIG. 4(b)) between the hammer cams 30a1 and 30a2 in the circumferential direction of the through-hole 30c. In this manner, only the pattern illustrated in FIG. 9(c) of the three patterns illustrated in FIGS. 9(a), 9(b), and 9(c) is not the preferable pattern, and the two patterns of the three patterns illustrated in FIGS. 9(a), 9(b), and 9(c) are configured so that the spindle 26 is pushed against the inclined portion 50.

The third embodiment formed as described above also has the same functional effects as those of the above-described second embodiment.

Next, a fourth embodiment of the present invention will be described in detail with reference to the drawings. Note that portions having the same functions as those of the above-described first to third embodiments will be denoted by the same reference signs, and the detailed description thereof will be omitted. In addition, a shape and a size of each portion are the same as those of the above-described embodiments, and thus, will not be described.

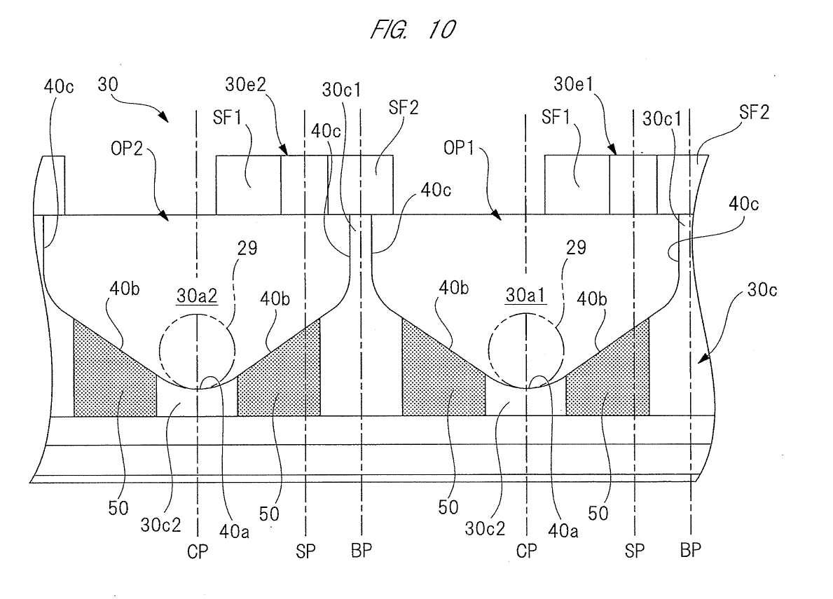

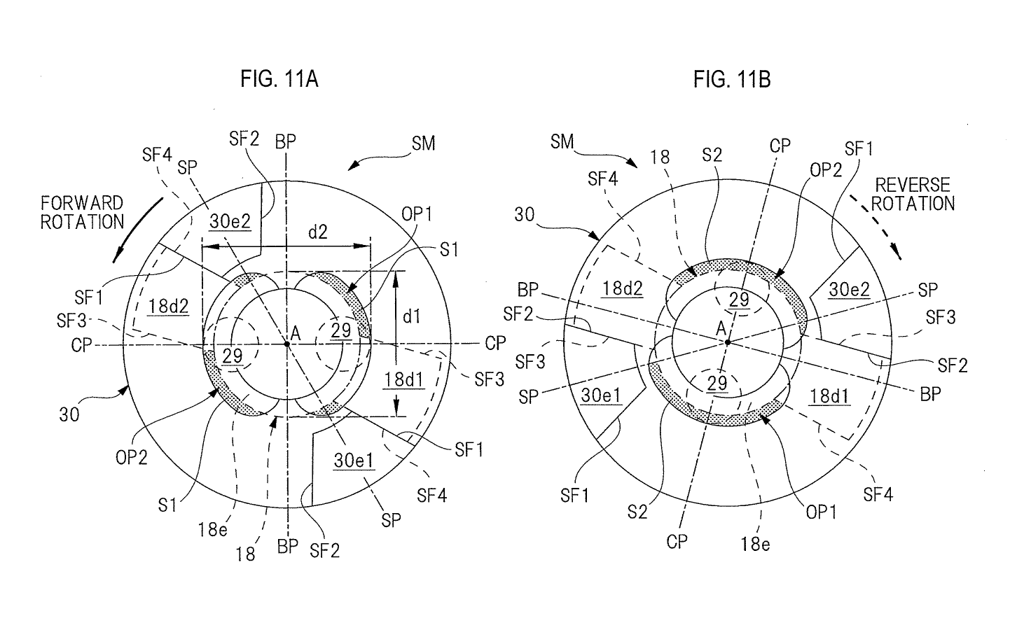

FIG. 10 illustrates a development view of a through-hole of a hammer, which corresponds to FIG. 4(b), and FIGS. 11(a) and 11(b) illustrate explanatory diagrams of operations obtained when an impact mechanism, obtained by applying the hammer of FIG. 10 to the impact mechanism of FIG. 3, is viewed from the shaft direction.

The hammer 30 illustrated in FIG. 10 is different from that of FIG. 4(b) in positions of the second pawls 30e1 and 30e2 with respect to the center portions CP of the two hammer cams 30a1 and 30a2 and in a fact that the steel ball 29 is added, and the other structures and functions are the same as those of FIG. 4(b). Specifically, as illustrated in FIG. 10, the second pawls 30e1 and 30e2 of the hammer 30 are positioned on the right of the drawing with respect to the center portion CP. In addition, the steel ball 29 is disposed in each of the circular arc portions 40a of the two hammer cams 30a1 and 30a2. In FIG. 4(b), note that the steel ball 29 is omitted.

As illustrated in FIG. 3, the anvil 18 is provided with a main body 18c formed in a substantially cylindrical shape. An overlapping portion 18e formed in a substantially disc shape is integrally formed with a portion of the main body 18c, the portion being closer to the hammer 30 in the shaft direction. A diameter size d1 of the overlapping portion 18e is set to be a size which is slightly smaller than a distance d2 (see FIG. 11(a)) connecting radially outer sides of the pair of opening portions OP1 and OP2 (d1<d2). Accordingly, in a state in which the hammer 30 and the anvil 18 are assembled with each other, the overlapping portion 18e overlaps a half of each of the opening portions OP1 and OP2 or more in the shaft direction of the spindle 26, and overlaps the steel ball 29. Accordingly, as illustrated in the shaded portions of FIG. 11, each opening area S1 of the opening portions OP1 and OP2 can be smaller than that of the conventional technique.

The overlapping portion 18e is provided integrally with the two first pawls 18d1 and 18d2 so that the first pawls oppose each other while taking the main body 18c as the center. The first pawls 18d1 and 18d2 are provided to protrude toward the radially outer side of the overlapping portion 18e and are disposed at an interval of 180 degrees in the circumferential direction of the overlapping portion 18e. Each cross-sectional shape of the first pawls 18d1 and 18d2 in a direction intersecting the shaft A is a substantially rectangular shape. Here, each boundary portion between the overlapping portion 18e and each of the first pawls 18d1 and 18d2 is indicated by the alternate long and short dash line in FIG. 11.

Here, as illustrated in FIG. 11(a), in a state in which the first pawls 18d1 and 18d2 and the second pawls 30e1 and 30e2 are engaged with (contact) each other during forward rotation, the first pawls 18d1 and 18d2 are positioned at positions at which the center portions CP of the hammer cams 30a1 and 30a2 overlap each other when viewed from the shaft direction of the spindle 26. That is, the overlapping portion 18e not only overlaps each half of the opening portions OP1 and OP2 or more when viewed from the shaft direction of the spindle 26 but also closes each of the opening portions OP1 and OP2 by using the first pawls 18d1 and 18d2. Furthermore, the first pawls 18d1 and 18d2 also overlap the steel balls 29 when viewed from the shaft direction of the spindle 26. Accordingly, the opening area S1 of each of the opening portions OP1 and OP2 can be further reduced, and thus, the leak of the grease from the opening portions OP1 and OP2 can be suppressed, and further, the drop off of the steel balls 29 from the opening portions OP1 and OP2 can be also suppressed. That is, when the screw is tightened by the impact driver 10, a large amount of the grease adheres to the steel ball 29 as rolling inside each of the hammer cams 30a1 and 30a2 and the spindle cams 26b1 and 26b2. Further, the steel ball 29 to which the grease adheres vigorously moves fast inside each of the spindle cams 26b1 and 26b2 toward the anvil 18. In addition, the steel ball 29 moves fast from the wall portion 30c1 toward the bottom portion 30c2 of each of the hammer cams 30a1 and 30a2. Accordingly, the steel balls 29 push the grease remaining in the bottom portions 30c2 of the hammer cams 30a1 and 30a2 toward the opening portions OP1 and OP2, and further, the grease adhering to the steel balls 29 reach the opening portions OP1 and OP2 of the hammer cams 30a1 and 30a2, and then, leaks to the outside of the hammer 30.

However, in the present embodiment as illustrated in FIG. 11(a), each half of the opening portions OP1 and OP2 or more overlaps the overlapping portion 18e provided in the anvil 18. Further, during the “forward rotation” performed when the screw is tightened or others, the first pawls 18d1 and 18d2 overlap the steel balls 29 when viewed from the shaft direction of the spindle 26 (the anvil 18) in a state in which the first pawls 18d1 and 18d2 and the second pawls 30e1 and 30e2 are engaged with each other. Furthermore, the first pawls 18d1 and 18d2 overlap the center portions CP of the hammer cams 30a1 and 30a2 (top portions of the bottom portions 30c2 of the hammer cams 30a1 and 30a2). This manner suppresses the leak of the grease adhering to the steel balls 29 or the grease pushed out by the steel balls 29 from the opening portions OP1 and OP2 of the hammer cams 30a1 and 30a2 to the outside of the hammer 30. In addition, the drop off of the steel balls 29 from the opening portions OP1 and OP2 can be also suppressed.

Note that, when the rotation direction of the electric motor 12 is reversed by an operation of the forward and reverse switching lever 16, the impact force can be applied in the reverse direction to that of the above-described operation. Accordingly, the tightened screw can be loosened. As illustrated in FIG. 11(b), this case causes a state in which the second contact plane SF2 of the second pawl 30e2 and the third contact plane SF3 of the first pawl 18d1 are in contact with each other and a state in which the second contact plane SF2 of the second pawl 30e1 and the third contact plane SF3 of the first pawl 18d2 are in contact with each other. During “reverse rotation” performed when the screw is loosened or others, while the first pawls 18d1 and 18d2 do not overlap the steel balls 29 in the shaft direction of the spindle 26, each half of the opening portions OP1 and OP2 or more overlaps the overlapping portion 18e. Accordingly, the leak of the grease adhering to the steel ball 29 to the outside of the hammer 30 can be suppressed as substantially similar to the case of the “forward rotation” performed when the screw is tightened or others.

Here, each portion covering the opening portions OP1 and OP2 is smaller during the “reverse rotation” performed when the screw is loosened or others than the “forward rotation” performed when the screw is tightened or others. That is, an opening area S2 is slightly larger (S2>S1). However, in the usage of the impact driver 10, an impact operation during the screw loosening work is performed significantly less than an impact operation during the screw tightening work or others. Accordingly, in the present embodiment, there is almost no problem in a difference in each opening area of the opening portions OP1 and OP2 between the case of “forward rotation” and the case of “reverse rotation”.

As described above in detail, in the impact driver 10 according to the present embodiment, the overlapping portion 18e is provided in a portion of the anvil 18, the portion being closer to the hammer 30, the overlapping portion 18e overlapping the opening portions OP1 and OP2 of the hammer cams 30a1 and 30a2 in the shaft direction of the spindle 26. Therefore, when the first pawls 18d1 and 18d2 and the second pawls 30e1 and 30e2 are engaged with each other and the impact operation is performed, the leak of the grease adhering to the steel ball 29 to the outside can be suppressed. Accordingly, the stable operation of the impact driver 10 can be achieved over a long period of time.

Further, in the impact driver 10 according to the present embodiment, during the “forward rotation” performed when the screw is tightened or others, the first pawls 18d1 and 18d2 overlap the center portions CP of the hammer cams 30a1 and 30a2, in other words, overlap the steel balls 29 when viewed from the shaft direction of the spindle 26 in the state in which the first pawls 18d1 and 18d2 and the second pawls 30e1 and 30e2 are engaged with each other. Therefore, during the “screw tightening work or others” which is the most frequent usage of the impact driver 10, the leak of the grease adhering to the steel balls 29 from the opening portions OP1 and OP2 of the hammer cams 30a1 and 30a2 to the outside of the hammer 30 can be effectively suppressed. In addition, the drop off of the steel balls 29 from the opening portions OP1 and OP2 can be further suppressed.

Next, a fifth embodiment of the present invention will be described in detail with reference to the drawings. Note that portions having the same functions as those of the above-described first to fourth embodiments will be denoted by the same reference signs, and the detailed description thereof will be omitted.

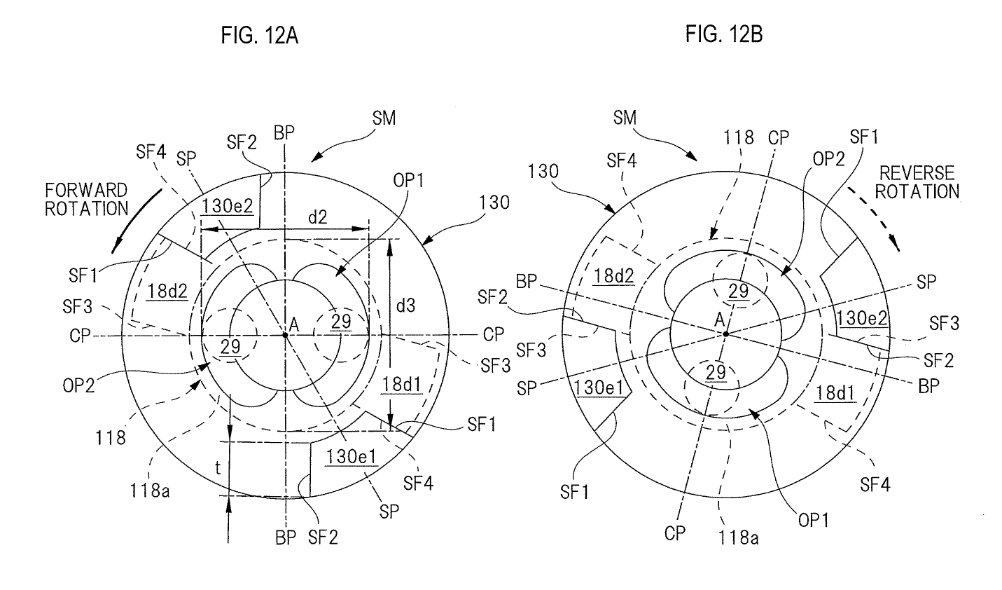

FIGS. 12(a) and 12(b) are corresponding views of FIGS. 11(a) and 11(b) illustrating an impact mechanism of the fifth embodiment.

As illustrated in FIG. 12, the fifth embodiment is different from the first embodiment in only each structure of the hammer (impact member) 130 and the anvil (output member) 118 which form the impact mechanism SM. Specifically, a diameter size d3 of an overlapping portion 118a provided in the anvil 118 is set to be a size which is slightly larger than the distance d2 connecting the radially outer sides of the pair of opening portions OP1 and OP2 (d3>d2). In addition, each radial size (protruding size from the overlapping portion 118a toward the radially outer side) “t” of the second pawls 130e1 and 130e2 provided in the hammer 130 is set to be thinner than that of the fourth embodiment (see FIG. 11) because of the large diameter size d3 of the overlapping portion 118a. That is, in the second embodiment, the overlapping portion 118a overlaps the entire opening portions OP1 and OP2 in the shaft direction of the spindle 26 (the anvil 118).

The fifth embodiment formed as described above also has substantially the same functional effects as those of the above-described fourth embodiment. In addition, in the fifth embodiment, the overlapping portion 118a overlaps the entire opening portions OP1 and OP2, and therefore, the leak of the grease adhering to the steel ball 29 to the outside can be further reliably suppressed. However, in order to secure the sufficient rigidity of each of the second pawls 130e1 and 130e2, it is desirable to enhance the rigidity of the hammer 130 more than that in the fourth embodiment. In addition, the overlapping portion 118a of the fifth embodiment is formed to be larger (heavier) than the overlapping portion 18e of the fourth embodiment, and thus, a rising rate of the electric motor 12 up to a target rotational speed in the activation of the electric motor 12 decreases. However, the electric motor 12 can continuously rotate even after stopping the electric motor 12 by an inertial force because the inertia is large, and as a result, the screw can be tightened at the same level as the fourth embodiment.

Next, a sixth embodiment of the present invention will be described in detail with reference to the drawings. Note that portions having the same functions as those of the above-described fourth embodiment will be denoted by the same reference signs, and the detailed description thereof will be omitted.

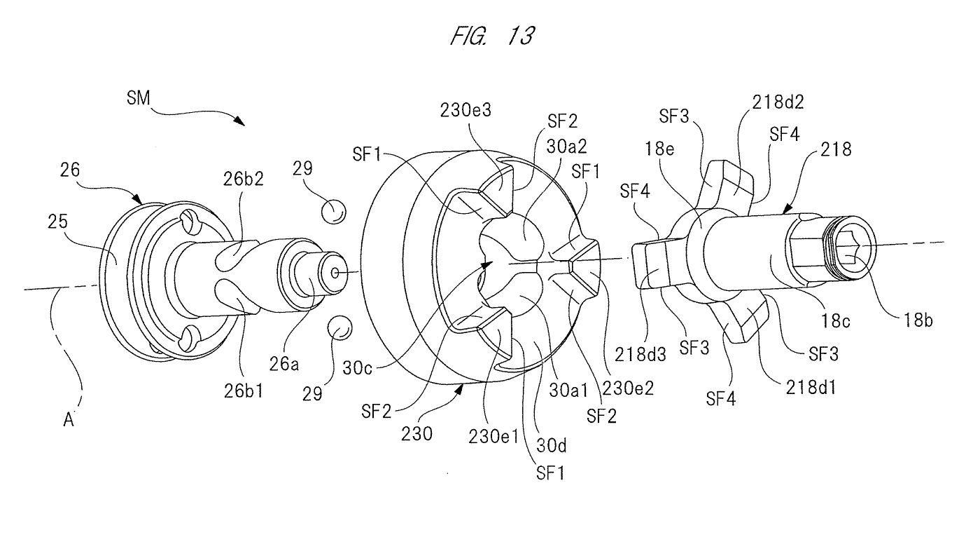

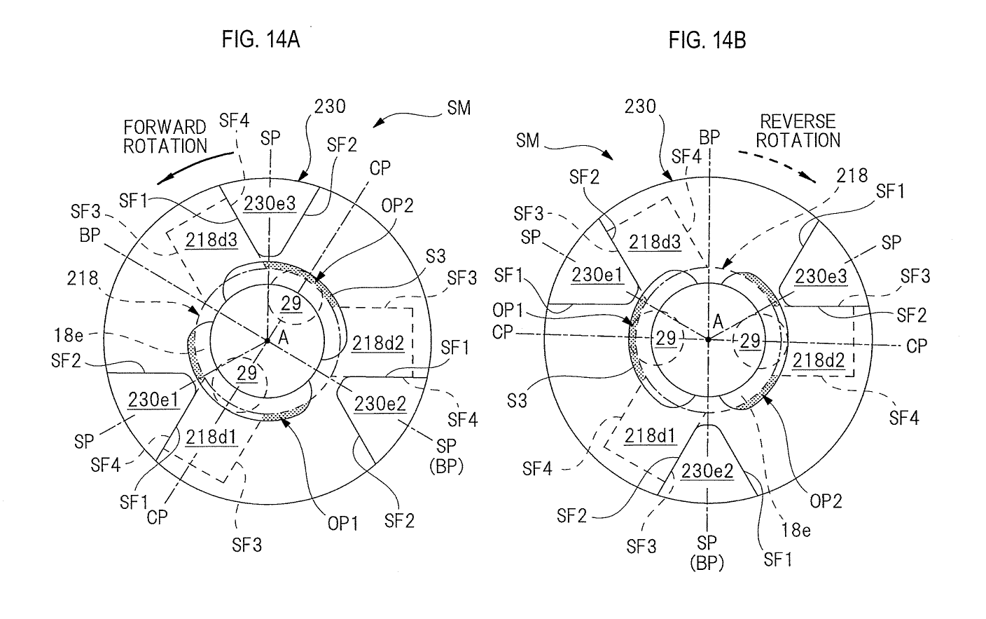

FIG. 13 is an exploded perspective view of an impact mechanism of the sixth embodiment, and FIGS. 14(a) and 14(b) illustrate explanatory diagrams of operations obtained when the impact mechanism of FIG. 13 is viewed from the shaft direction. Note that the impact mechanism of FIG. 13 has the same function (structure) as that of the impact mechanism of FIG. 7. However, a hammer is denoted by a different reference sign for convenience.

As illustrated in FIGS. 13 and 14, the sixth embodiment is different from the fourth embodiment in only each structure of a hammer (impact member) 230 and an anvil (output member) 218 which form the impact mechanism SM. Specifically, the hammer 230 is provided with three second pawls 230e1, 230e2 and 230e3. These second pawls 230e1, 230e2 and 230e3 are disposed at an interval of 120 degrees in the circumferential direction of the opposed plane 30d.

The first contact plane SF1 is provided on one side of each of the second pawls 230e1, 230e2 and 230e3 in the circumferential direction of the hammer 230. In addition, the second contact plane SF2 is provided on the other side of each of the second pawls 230e1, 230e2 and 230e3 in the circumferential direction of the hammer 230. Further, the substantially entire fourth contact plane SF4 of each of first pawls 218d1, 218d2 and 218d3 of the anvil 218 is in contact with the first contact plane SF1, and the substantially entire third contact plane SF3 of each of the first pawls 218d1, 218d2 and 218d3 of the anvil 218 is in contact with the second contact plane SF2.

In addition, each width size of the second pawls 230e1, 230e2, and 230e3 positioned on an outer side of the hammer 130 in the radial direction and formed in the circumferential direction is set to be about 10 mm. Accordingly, each of the first pawls 218d1, 218d2, and 218d3 of the anvil 218 enters among the second pawls 230e1, 230e2, and 230e3 of the hammer 230 which are adjacent to each other in the circumferential direction with a sufficient margin.

The overlapping portion 18e of the anvil 218 is provided integrally with the three first pawls 218d1, 218d2 and 218d3 protruding toward the radially outer side. The first pawls 218d1, 218d2 and 218d3 are disposed at an interval of 120 degrees in the circumferential direction of the overlapping portion 18e.

The third contact plane SF3 is provided on one side of each of the first pawls 218d1, 218d2 and 218d3 in the circumferential direction of the anvil 218. In addition, the fourth contact plane SF4 is provided on the other side of each of the first pawls 218d1, 218d2 and 218d3 in the circumferential direction of the anvil 218. Further, the substantially entire second contact plane SF2 of each of the second pawls 230e1, 230e2 and 230e3 of the hammer 230 is in contact with the third contact plane SF3, and the substantially entire first contact plane SF1 of each of the second pawls 230e1, 230e2 and 230e3 of the hammer 230 is in contact with the fourth contact plane SF4.

In addition, each width size of the first pawls 218d1, 218d2, and 218d3 positioned on an outer side of the anvil 218 in the radial direction and formed in the circumferential direction is set to be about 10 mm. That is, the width size is set to be substantially the same width size of each of the second pawls 230e1, 230e2, and 230e3 of the hammer 230. Accordingly, each of the second pawls 230e1, 230e2, and 230e3 of the hammer 230 enters among the first pawls 218d1, 218d2, and 218d3 of the anvil 218 which are adjacent to each other in the circumferential direction with a sufficient margin.

Here, positions of the two hammer cams 30a1 and 30a2 provided in the hammer 230 and positions of the three second pawls 230e1, 230e2 and 230e3 provided in the hammer 230 are set to have the following positional relation. That is, the two second pawls 230e1 and 230e3 among the three second pawls 230e1, 230e2 and 230e3 are provided at the positions shifted from the wall portion 30c1 and the bottom portion 30c2 (see FIG. 10) in the circumferential direction of the hammer 230. That is, the top portion SP of each of the second pawls 230e1 and 230e3 is within the range of the inclined portion 50 (see FIG. 10) in the circumferential direction of the through-hole 30c. On the other hand, one second pawl 230e2 among the three second pawls 230e1, 230e2 and 230e3 is provided at a position of the wall portion 30c1 in the circumferential direction of the hammer 230.

Further, as illustrated in FIG. 14(a), during the “forward rotation” performed when the screw is tightened or others, the first pawl 218d1 overlaps the steel ball 29 when viewed from the shaft direction of the spindle 26 (the anvil 218) in a state in which the first pawls 218d1, 218d2, and 218d3 and the second pawls 230e1, 230e2, and 230e2 are engaged with each other. This manner suppresses the leak of the grease adhering to the steel ball 29 from the opening portion OP1 of the hammer cam 30a1 to the outside of the hammer 230. At this time, a total opening area (a shaded portion in the drawing) of the opening portions OP1 and OP2 is expressed as “S3”.

Further, during the “reverse rotation” performed when the screw is loosened or others, the first pawl 218d2 overlaps the steel ball 29 when viewed from the shaft direction of the spindle 26 in a state in which the first pawls 218d1, 218d2, and 218d3 and the second pawls 230e1, 230e2, and 230e2 are engaged with each other. This manner suppresses the leak of the grease adhering to the steel ball 29 from the opening portion OP2 of the hammer cam 30a2 to the outside of the hammer 230. At this time, a total opening area of the opening portions OP1 and OP2 is also expressed as “S3” as similar to the case of “forward rotation”.

The sixth embodiment formed as described above also has substantially the same functional effects as those of the above-described fourth embodiment. In addition, in the sixth embodiment, the total opening area of the opening portions OP1 and OP2 can be the same as S3 between the case of “forward rotation” performed when the screw is tightened or others and the case of “reverse rotation” performed when the screw is loosened or others. Therefore, regardless of the “forward rotation” and the “reverse rotation”, the leak of the grease adhering to the steel ball 29 to the outside can be effectively suppressed. In addition, in the sixth embodiment, the three first pawls and the three second pawls are provided, and therefore, an impact efficiency can be improved, and further, work time or others can be shortened.

Next, a seventh embodiment of the present invention will be described in detail with reference to the drawings. Note that portions having the same functions as those of the above-described sixth embodiment will be denoted by the same reference signs, and the detailed description thereof will be omitted.

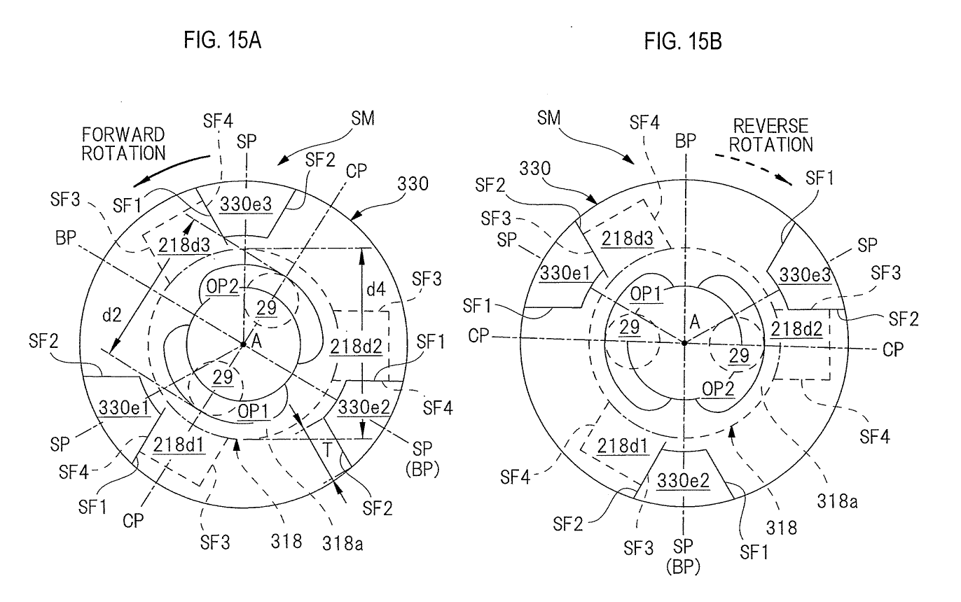

FIG. 15 are corresponding views of FIG. 11 illustrating an impact mechanism of the seventh embodiment.

As illustrated in FIG. 15, the seventh embodiment is different from the sixth embodiment in only each structure of the hammer (impact member) 330 and the anvil (output member) 318 which form the impact mechanism SM. Specifically, a diameter size d4 of an overlapping portion 318a provided in the anvil 318 is set to be a size which is slightly larger than the distance d2 connecting the radially outer sides of the pair of opening portions OP1 and OP2 (d4>d2). In addition, each radial size (thickness size) “T” of the second pawls 330e1, 330e2, and 330e3 provided in the hammer 330 is set to be thinner than that of the sixth embodiment (see FIG. 14) because of the large diameter size d4 of the overlapping portion 318a. That is, in the seventh embodiment, the overlapping portion 318a overlaps the entire opening portions OP1 and OP2 in the shaft direction of the spindle 26 (the anvil 318).

The seventh embodiment formed as described above also has substantially the same functional effects as those of the above-described sixth embodiment. In addition, in the seventh embodiment, the overlapping portion 318a overlaps the entire opening portions OP1 and OP2, and therefore, the leak of the grease adhering to the steel ball 29 to the outside can be further reliably suppressed. However, in order to secure the sufficient rigidity of each of the second pawls 330e1, 330e2, and 330e3, it is desirable to enhance the rigidity of the hammer 330 more than that in the third embodiment.

It is needless to say that the present invention is not limited to the foregoing embodiments and various modifications and alterations can be made within the scope of the present invention. For example, the impact tool of the present invention includes not only the impact driver 10 described above but also an impact wrench or others. In addition, the impact tool of the present invention includes a structure in which power of an alternate-current power supply can be supplied to the electric motor 12 without using the battery pack 11. Further, the impact tool of the present invention includes a structure in which the power of the battery pack 11 and the power of the alternate-current power supply can be switched and supplied to the electric motor 12.

Further, the driving source of the present invention includes not only the electric motor 12 described above but also an engine, a pneumatic motor, a hydraulic motor, and others. The engine is a motive power source that converts heat energy, which is generated by burning fuel, into kinetic energy, and includes, for example, a gasoline engine, a diesel engine, and besides, a liquefied petroleum gas engine. The electric motor 12 includes a motor with a brush, a brushless motor, and others. Further, the impact tool of the present invention includes not only the structure in which the tip tool 17 is directly attached to the anvil 18, 118, 218 or 318 but also a structure in which a tip tool is attached to an anvil via a socket, an adapter, or others.

### Explanation of Reference Characters

10 impact driver (impact tool)
11 battery pack
12 electric motor
13 casing
14 rotation shaft
15 trigger switch
16 forward and reverse switching lever
17 tip tool
18 anvil (output member)
18a holding hole
18b attachment hole
18c main body
18d1, 18d2 first pawl
18e overlapping portion
19 sleeve
20 detachable mechanism
21 decelerator
22 sun gear
23 ring gear
24 planetary gear
25 carrier
26 spindle (rotating member)
26a shaft
26b1, 26b2 spindle cam
27 holder member
28 bearing
29 steel ball
30 hammer (impact member)
30a1,30a2 hammer cam (cam groove)
30b main body
30c through-hole
30c1 wall portion
30c2 bottom portion
30d opposed plane
30e1, 30e2 second pawl
31 annular plate
32 coil spring
33 stopper
40a circular arc portion
40b inclined portion (inclined part)
40c linear portion
50 inclined portion (pressing portion, trapezoid-shaped portion)
118 anvil (output member)
118a overlapping portion
118d1, 118d2, 118d3 first pawl
130 hammer (impact member)
130e1, 130e2, 130e3 second pawl
218 anvil (output member)
218d1, 218d2, 218d3 first pawl
230 hammer (impact member)
230e1, 230e2, 230e3 second pawl
318 anvil (output member)
318a overlapping portion
330 hammer (impact member)
330e1, 330e2, 330e3 second pawl
BP center portion of wall portion
CP center portion of hammer cam
SP top portion of second pawl
OP1, OP2 opening portion
SF1 first contact plane
SF2 second contact plane
SF3 third contact plane
SF4 fourth contact plane
SM impact mechanism
U hollowed portion

1. An impact tool which applies a torque and an impact force to a tip tool, comprising:
a motor;
a spindle rotated by the motor;
an anvil to which the tip tool is attached; and
a hammer which converts a torque of the spindle into a torque and an impact force of the anvil,
wherein the hammer includes:
a second pawl to be engaged with a first pawl of the anvil;
a through-hole through which the spindle passes;
a plurality of cam grooves hollowed toward a radially outer side of the through-hole;
a wall portion provided between the plurality of cam grooves in a circumferential direction of the through-hole; and
a bottom portion positioned at a center portion of the cam groove in the circumferential direction of the through-hole, and
the second pawl is provided between the bottom portion and the wall portion in the circumferential direction of the through-hole.

2. The impact tool according to claim 1,
wherein a top portion of the second pawl provided at a center portion in the circumferential direction on a radially inner side is positioned between the bottom portion and the wall portion.

3. The impact tool according to claim 1,
wherein a plurality of the second pawls are provided, and at least one of the plurality of second pawls is provided between the bottom portion and the wall portion.

4. The impact tool according to claim 3,
wherein each number of the first pawls and the second pawls is three.

5. An impact tool which applies a torque and an impact force to a tip tool, comprising:
a motor;
a spindle rotated by the motor;
an anvil to which the tip tool is attached; and
a hammer which converts a torque of the spindle into a torque and an impact force of the anvil,
wherein the hammer includes:
a second pawl to be engaged with a first pawl of the anvil;
a through-hole through which the spindle passes;
a pair of cam grooves hollowed toward a radially outer side of the through-hole;
a wall portion provided between the pair of cam grooves in a circumferential direction of the through-hole;
a bottom portion positioned at a center portion of each of the pair of cam grooves in the circumferential direction of the through-hole; and
an inclined portion which is positioned between the wall portion and the bottom portion in the circumferential direction of the through-hole and which connects the wall portion and the bottom portion,
the cam groove is formed by sequentially providing the wall portion, the inclined portion, the bottom portion, the inclined portion, and the wall portion in the circumferential direction of the through-hole, and
a center portion of the second pawl in the circumferential direction is positioned within a range of one of the inclined portions, and the spindle is pushed against the other of the inclined portions when the first pawl and the second pawl are engaged with each other.

6. The impact tool according to claim 5,
wherein a plurality of the second pawls are provided, a center portion of at least one of the plurality of second pawls in the circumferential direction is positioned within a region of one of the inclined portions, and the spindle is pushed against the other of the inclined portions when the first pawl and the second pawl are engaged with each other.

7. The impact tool according to claim 6,
wherein each number of the first pawls and the second pawls is three.

8. An impact tool which applies a torque and an impact force to a tip tool, comprising:
a motor;
a spindle rotated by the motor;
an anvil which includes a first pawl and to which the tip tool is attached on a front side; and
a hammer which is provided on a rear side of the anvil, and having a second pawl and which is engaged with the first pawl and a cam groove whose front side is opened, whose rear side has a bottom portion, and which holds a steel ball together with the spindle, and converting a torque of the spindle into a torque and an impact force of the anvil,
wherein the first pawl overlaps the bottom portion of the cam groove when viewed from a shaft direction of the spindle in a state in which the first pawl and the second pawl are engaged with each other.

9. The impact tool according to claim 8,
wherein a plurality of the first pawls are provided, and at least one of the plurality of first pawls overlaps the bottom portion.

10. The impact tool according to claim 8,
wherein the first pawl overlaps the steel ball when viewed from a shaft direction of the spindle in a state in which the first pawl and the second pawl are engaged with each other.

11. The impact tool according to claim 10,
wherein each number of the first pawls and the second pawls is three.
